(19) United States
(12) Patent Application Publication
(10) Pub. No.: US 2025/0209711 A1
(43) Pub. Date: Jun. 26, 2025

(54) TRAJECTORY INFORMATION PROCESSING METHOD, COMPUTER DEVICE, AND READABLE STORAGE MEDIUM

(71) Applicant: TENCENT TECHNOLOGY (SHENZHEN) COMPANY LIMITED, Shenzhen (CN)

(72) Inventors: Zelin YE, Shenzhen (CN); Xiya JIA, Shenzhen (CN); Xinghui FU, Shenzhen (CN); Zhongqian SUN, Shenzhen (CN)

(21) Appl. No.: 19/075,391

(22) Filed: Mar. 10, 2025

Related U.S. Application Data
(63) Continuation of application No. PCT/CN2023/131147, filed on Nov. 13, 2023.

(30) Foreign Application Priority Data
Feb. 15, 2023 (CN) 202310163986.3

(51) Int. Cl. G06T 13/40

(52) U.S. Cl. CPC G06T 13/40

(57) ABSTRACT

A trajectory information processing method includes obtaining respective limb trajectory information of at least two first limbs of a first object; migrating the limb trajectory information from a first limb of the first object to a corresponding second limb of a second object, to obtain initial trajectory information of the second limb; determining limb posture information of the first limb and limb interaction information between the at least two first limbs; pre-correcting the initial trajectory information of the second limb, to obtain predicted posture information of the second limb and predicted interaction information between the at least two second limbs; determining single-limb constraint information between the first limb and the corresponding second limb; determining limb interaction constraint information between the first object and the second object; and correcting the initial trajectory information of the second limb, to obtain target trajectory information of the second limb.

### CROSS-REFERENCES TO RELATED APPLICATIONS

The present disclosure is a continuation application of PCT Patent Application No. PCT/CN2023/131147, filed on Nov. 13, 2023, which claims priority to Chinese Patent Application No. 2023101639863, filed on Feb. 15, 2023, all of which is incorporated by reference in their entirety.

### FIELD OF THE TECHNOLOGY

The present disclosure relates to the field of computer technologies and, in particular, to a trajectory information processing method and apparatus, a computer device, a computer-readable storage medium, and a computer program product.

### BACKGROUND OF THE DISCLOSURE

In animation production, animation retargeting is intended to migrate an existing animation resource to a new character. The animation production efficiency may thus be improved. For example, a footstep trajectory of character A may be migrated to character B. Corresponding footstep trajectory then does not need to be separately produced for each character.

Often, each lower limb of a character is independently processed, a footstep trajectory of each lower limb of the character is equally scaled according to lengths of the limbs of two characters, and a footstep trajectory obtained by scaling is used as a footstep trajectory of a new character.

However, the scaling and migration of the footstep trajectory using the length of the lower limbs of the character do not take cooperation between the lower limbs of the character into account. Consequently, migration of the footstep trajectory is inaccurate.

### SUMMARY

One embodiment of the present disclosure provides a trajectory information processing method performed by a computer device. The method includes obtaining respective limb trajectory information of at least two first limbs of a first object, the at least two first limbs of the first object being in a one-to-one correspondence with at least two second limbs of a second object; migrating the limb trajectory information from a first limb of the at least two first limbs of the first object to a corresponding second limb of the at least two second limbs of the second object, to obtain initial trajectory information of the second limb; determining, based on the limb trajectory information of the first limb, limb posture information of the first limb and limb interaction information between the at least two first limbs; pre-correcting the initial trajectory information of the second limb, to obtain predicted posture information of the second limb and predicted interaction information between the at least two second limbs; determining, according to the limb posture information and the predicted posture information, single-limb constraint information between the first limb and the corresponding second limb; determining, according to the limb interaction information and the predicted interaction information, limb interaction constraint information between the first object and the second object; and correcting, based on the single-limb constraint information and the limb interaction constraint information, the initial trajectory information of the second limb, to obtain target trajectory information of the second limb.

Another embodiment of the present disclosure provides a computer device. The device includes one or more processors and a memory containing computer-readable instructions that, when being executed, cause the one or more processors to perform: obtaining respective limb trajectory information of at least two first limbs of a first object, the at least two first limbs of the first object being in a one-to-one correspondence with at least two second limbs of a second object; migrating the limb trajectory information from a first limb of the at least two first limbs of the first object to a corresponding second limb of the at least two second limbs of the second object, to obtain initial trajectory information of the second limb; determining, based on the limb trajectory information of the first limb, limb posture information of the first limb and limb interaction information between the at least two first limbs; pre-correcting the initial trajectory information of the second limb, to obtain predicted posture information of the second limb and predicted interaction information between the at least two second limbs; determining, according to the limb posture information and the predicted posture information, single-limb constraint information between the first limb and the corresponding second limb; determining, according to the limb interaction information and the predicted interaction information, limb interaction constraint information between the first object and the second object; and correcting, based on the single-limb constraint information and the limb interaction constraint information, the initial trajectory information of the second limb, to obtain target trajectory information of the second limb.

Another embodiment of the present disclosure provides a non-transitory computer-readable storage medium containing computer-readable instructions that, when being executed, cause at least one processor to perform: obtaining respective limb trajectory information of at least two first limbs of a first object, the at least two first limbs of the first object being in a one-to-one correspondence with at least two second limbs of a second object; migrating the limb trajectory information from a first limb of the at least two first limbs of the first object to a corresponding second limb of the at least two second limbs of the second object, to obtain initial trajectory information of the second limb; determining, based on the limb trajectory information of the first limb, limb posture information of the first limb and limb interaction information between the at least two first limbs; pre-correcting the initial trajectory information of the second limb, to obtain predicted posture information of the second limb and predicted interaction information between the at least two second limbs; determining, according to the limb posture information and the predicted posture information, single-limb constraint information between the first limb and the corresponding second limb; determining, according to the limb interaction information and the predicted interaction information, limb interaction constraint information between the first object and the second object; and correcting, based on the single-limb constraint information and the limb interaction constraint information, the initial trajectory information of the second limb, to obtain target trajectory information of the second limb.

Details of one or more embodiments of the present disclosure are provided in the accompanying drawings and descriptions below. Other features and advantages of the present disclosure become apparent with reference to the specification, the accompanying drawings, and the claims.

### BRIEF DESCRIPTION OF THE DRAWINGS

To describe the technical solutions in embodiments of the present disclosure or the related art more clearly, the following briefly describes the accompanying drawings required for describing the embodiments or the related art. Apparently, the accompanying drawings in the following descriptions show merely some embodiments of the present disclosure, and a person of ordinary skill in the art may still derive other drawings from these accompanying drawings without creative efforts.

FIG. 1 is a diagram of an application environment of a trajectory information processing method according to one embodiment of the present disclosure.

FIG. 2 is a schematic flowchart of a trajectory information processing method according to one embodiment of the present disclosure.

FIG. 3 is a schematic diagram of a first object in a preset posture according to one embodiment of the present disclosure.

FIG. 4 is a schematic diagram of a first object in a preset posture in another embodiment.

FIG. 5 is a schematic flowchart of determining target trajectory information of a second limb according to one embodiment of the present disclosure.

FIG. 6 is a schematic flowchart of determining target offset information corresponding to a second limb from candidate offset information of each iteration according to one embodiment of the present disclosure.

FIG. 7 is a schematic overall flowchart of a trajectory information processing method according to one embodiment of the present disclosure.

FIG. 8 is a schematic diagram of a joint chain and a single-joint chain constraint of a human character according to one embodiment of the present disclosure.

FIG. 9 is a schematic diagram of a multi-joint chain constraint according to one embodiment of the present disclosure.

FIG. 10 is a schematic flowchart of forming a target constraint according to one embodiment of the present disclosure.

FIG. 11 is a schematic diagram of an offset according to one embodiment of the present disclosure.

FIG. 12 is a structural block diagram of a trajectory information processing apparatus according to one embodiment of the present disclosure.

FIG. 13 is a diagram of an internal structure of a computer device according to one embodiment of the present disclosure.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

Embodiments of the present disclosure may be applied to various scenes, including but not limited to a cloud technology, artificial intelligence (AI), intelligent transportation, and assisted driving. For example, embodiments of the present disclosure may be applied to the field of an AI technology. AI is a theory, method, technology, and application system that uses a digital computer or a machine controlled by the digital computer to simulate, extend, and expand human intelligence, perceive an environment, acquire knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making. Solutions provided in embodiments of the present disclosure relate to an AI trajectory information processing method and an information recommendation method, which are specifically described by using the following embodiments.

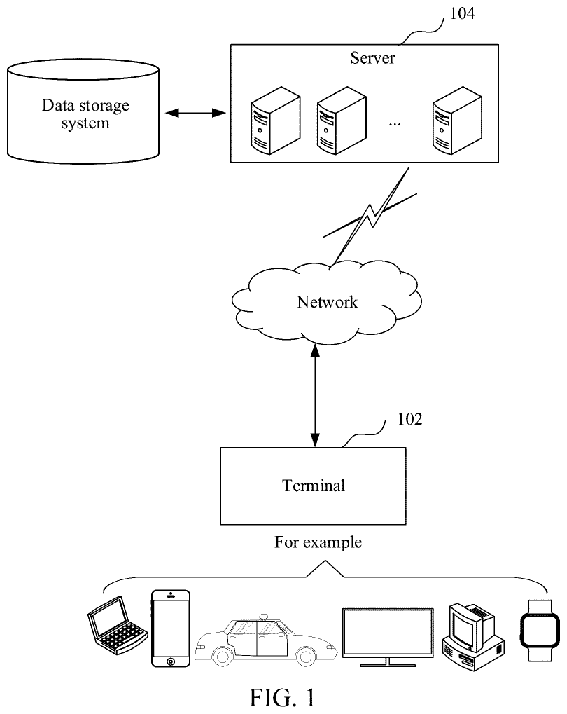

A trajectory information processing method provided in embodiments of the present disclosure may be applied to an application environment shown in FIG. 1. A terminal 102 communicates with a server 104 via a network. A data storage system may store data that needs to be processed by the server 104. The data storage system may be integrated on the server 104, or may be placed on a cloud or another server. Both the terminal 102 and the server 104 may be separately configured to execute the trajectory information processing method provided in embodiments of the present disclosure. The terminal 102 and the server 104 may further be cooperatively configured to execute the trajectory information processing method provided in embodiments of the present disclosure. When the terminal 102 and the server 104 are cooperatively configured to execute the trajectory information processing method provided in embodiments of the present disclosure, the terminal 102 obtains respective limb trajectory information of at least two first limbs of a first object, where the at least two first limbs of the first object are in a one-to-one correspondence with at least two second limbs of a second object. The terminal 102 migrates the limb trajectory information from each first limb of the first object to the corresponding second limb of the second object, to obtain initial trajectory information of each second limb. The terminal 102 transmits the individual limb trajectory information and the individual initial trajectory information to the server 104. The server 104 determines, based on the limb trajectory information of each first limb, limb posture information of each first limb and limb interaction information between the at least two first limbs. The server 104 pre-corrects the initial trajectory information of each second limb, to obtain predicted posture information of each second limb and predicted interaction information between the at least two second limbs. The server 104 determines, according to the limb posture information and the predicted posture information, single-limb constraint information between each first limb and the corresponding second limb. The server 104 determines, according to the limb interaction information and the predicted interaction information, limb interaction constraint information between the first object and the second object. The server 104 corrects, based on the single-limb constraint information and limb interaction constraint information of each second limb, the initial trajectory information of each second limb, to obtain target trajectory information of each second limb. The terminal 102 may be, but is not limited to, various desktop computers, notebook computers, smartphones, tablet computers, Internet of Things devices, and portable wearable devices. The Internet of Thing device may be a smart speaker, a smart television, a smart air conditioner, a smart in-vehicle device, or the like. The portable wearable device may be a smart watch, a smart band, a head-mounted device, or the like. The server 104 may be implemented by using an independent server or a server cluster including multiple servers.

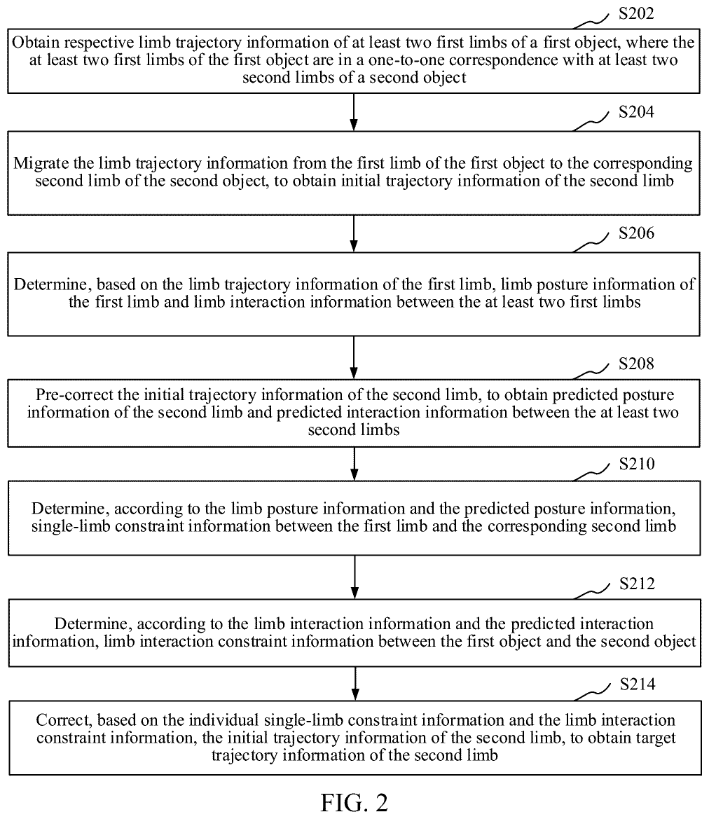

In one embodiment, as shown in FIG. 2, a trajectory information processing method is provided. An example in which the method is applied to a computer device (the computer device may be the terminal or the server in FIG. 1) in FIG. 1 is used for description. The method includes the following operations.

Operation S202: Obtain respective limb trajectory information of at least two first limbs of a first object, where the at least two first limbs of the first object are in a one-to-one correspondence with at least two second limbs of a second object.

The first object has a moving limb, and the limb of the first object includes multiple first limbs. Multiple means at least two. The first limb may be, for example, an upper limb, a lower limb, an anterior limb, or a posterior limb. The second object has a moving limb, and the limb of the second object includes multiple second limbs. The second limb may be, for example, an upper limb, a lower limb, an anterior limb, or a posterior limb. The at least two first limbs of the first object are in a one-to-one correspondence with the at least two second limbs of the second object. For example, a left upper limb of the first object corresponds to a left upper limb of the second object, and a right upper limb of the first object corresponds to a right upper limb of the second object.

The first object and the second object may be physical objects or virtual characters, and may be specifically physical model objects or virtual characters in a virtual scene, but are not limited thereto. The first object and the second object may be human objects or animal objects.

The first object and the second object belong to the same category of objects. For example, if the first object is a person, the second object is also a person. A quantity of the first limbs of the first object may be the same as a quantity of the second limbs of the second object.

The limb trajectory information refers to trajectory information corresponding to the first limb, and may be specifically trajectory information formed by positions of the first limb in different moments. The initial trajectory information refers to rough trajectory information corresponding to the second limb, and may be specifically trajectory information formed by rough positions of the second limb in different moments. The position may be a two-dimensional coordinate or a three-dimensional coordinate.

The computer device may determine a first object and a second object to which limb trajectory information is to be migrated. The computer device obtains the respective limb trajectory information of at least two first limbs of the first object.

Operation S204: Migrate the limb trajectory information from each first limb of the first object to the corresponding second limb of the second object, to obtain initial trajectory information of each second limb.

For each first limb, the computer device migrates the limb trajectory information of the first limb to a second limb corresponding to the first limb, to obtain initial trajectory information of the second limb, thereby obtaining the initial trajectory information of each second limb.

In this embodiment, the computer device determines original limb trajectory information of the second limb, and replaces the limb trajectory information of the second limb with the limb trajectory information corresponding to the first limb, to form the initial trajectory information of the second limb.

The original limb trajectory information of the second limb is original trajectory information of the second limb, and may be specifically trajectory information formed by positions of the second limb in different moments before the migration.

Operation S206: Determine, based on the limb trajectory information of each first limb, limb posture information of each first limb and limb interaction information between the at least two first limbs.

The limb posture information is information representing a posture of the first limb. The limb interaction information is information representing an interaction relationship between multiple first limbs. The interaction relationship between the multiple first limbs is referred to as a first interaction relationship.

The single-limb constraint information is constraint information between one first limb of the first object and a corresponding second limb of the second object. The single-limb constraint information is a constraint condition for a single first limb in a trajectory migration process, and specifically, is a limitation condition for the first limb that needs to be considered when the limb trajectory information of the first limb is migrated to the corresponding second limb.

The computer device obtains limb trajectory information of each first limb. For each first limb, the computer device determines, based on the limb trajectory information of the first limb, limb posture information of the first limb. The computer device determines, according to the limb trajectory information of each first limb, limb interaction information between the at least two first limbs.

Operation S208: Pre-correct the initial trajectory information of each second limb, to obtain predicted posture information of each second limb and predicted interaction information between the at least two second limbs.

The predicted posture information is information representing, after the initial trajectory information of the second limb is pre-corrected, a posture of the second limb after pre-correction. The predicted interaction information is information representing, after the initial trajectory information of the second limbs is pre-corrected, an interaction relationship between multiple second limbs after pre-correction. The information about the interaction relationship between the multiple second limbs is referred to as a second interaction relationship. The pre-correction is correction for pre-estimating the initial trajectory information of the second limb.

For each second limb, the computer device pre-corrects the initial trajectory information of the second limb, to obtain predicted trajectory information of the second limb, thereby obtaining the predicted trajectory information of each second limb. The predicted trajectory information is trajectory information of the second limb after pre-correction, and may be specifically trajectory information formed by positions of the second limb in different moments.

The computer device determines, based on the predicted trajectory information of the second limb, predicted posture information of the second limb, thereby obtaining the predicted posture information of each second limb. The computer device determines, based on the predicted trajectory information of each second limb, the predicted interaction information between the at least two second limbs.

Operation S210: Determine, according to the limb posture information and the predicted posture information, single-limb constraint information between each first limb and the corresponding second limb.

For each first limb of the first object, the second limb of the second object corresponding to the first limb is determined. The computer device determines a difference between the limb posture information of the first limb and the predicted posture information of the corresponding second limb, and uses the difference as the single-limb constraint information between the first limb and the corresponding second limb.

Operation S212: Determine, according to the limb interaction information and the predicted interaction information, limb interaction constraint information between the first object and the second object.

The limb interaction constraint information is multi-joint chain constraint information, and the limb interaction constraint information is a constraint on an interaction relationship between multiple limbs that interact with each other in a trajectory migration process.

The limb interaction constraint information is a constraint on an interaction relationship between multiple first limbs and an interaction relationship between multiple second limbs in a process in which the limb trajectory information of the multiple first limbs is migrated to the multiple second limbs.

The computer device determines limb interaction information between at least two first limbs of the first object. The computer device determines, according to the limb interaction information and the predicted interaction information, limb interaction constraint information between the first object and the second object.

The interaction relationship between the multiple first limbs is referred to as a first interaction relationship. The information about the interaction relationship between the multiple second limbs is referred to as a second interaction relationship. The limb interaction constraint information between the first object and the second object is a constraint between the first interaction relationship and the second interaction relationship.

Operation S214: Correct, based on the individual single-limb constraint information and the limb interaction constraint information, the initial trajectory information of each second limb, to obtain target trajectory information of each second limb.

The target trajectory information is final trajectory information of the second limb, and may be specifically trajectory information formed by final positions of the second limb in different moments. The position may be a two-dimensional coordinate or a three-dimensional coordinate.

For each second limb, the computer device corrects, according to the single-limb constraint information and the limb interaction constraint information of the second limb, the initial trajectory information of the second limb, to obtain the target trajectory information of the second limb.

In one embodiment, the operation of pre-correcting the initial trajectory information of each second limb, to obtain predicted posture information of each second limb and predicted interaction information between the at least two second limbs includes:

obtaining candidate offset information of each iteration; and pre-correcting, for each iteration, the initial trajectory information of each second limb based on the candidate offset information of the iteration, to obtain the predicted posture information of each second limb and the predicted interaction information between the at least two second limbs.

The operation of determining, according to the limb posture information of each first limb and the predicted posture information of the corresponding second limb, single-limb constraint information between each first limb and the corresponding second limb includes: determining, for each first limb in each iteration, single-limb constraint information between each first limb and the corresponding second limb according to the limb posture information of the first limb and the predicted posture information of the corresponding second limb.

The operation of determining, according to the limb interaction information and the predicted interaction information, limb interaction constraint information between the first object and the second object includes: generating, according to the limb interaction information and the predicted interaction information in each iteration, the limb interaction constraint information between the first object and the second object in each iteration.

The operation of correcting, based on the individual single-limb constraint information and the limb interaction constraint information, the initial trajectory information of each second limb, to obtain target trajectory information of each second limb includes: correcting, based on single-limb constraint information and limb interaction constraint information of each iteration, the initial trajectory information of each second limb, to obtain the target trajectory information of each second limb.

The candidate offset information is preset offset information in each iteration, and the candidate offset information used in a next iteration may be obtained after a preset step is adjusted according to the candidate offset information in a previous iteration. For example, the candidate offset information in a first iteration is (0, 0), and the preset step is 0.5. After the first iteration is completed, the candidate offset information (0, 0) is adjusted based on the preset step. To be specific, the candidate offset information in a second iteration is (0.5, 0.5), and the second iteration is entered. After the second iteration is completed, the candidate offset information (0.5, 0.5) is adjusted. To be specific, the candidate offset information in a third iteration is (1, 1), and the third iteration is entered.

The computer device may obtain the candidate offset information of each iteration. In an iteration, for each second limb, the initial trajectory information of the second limb is pre-corrected according to the candidate offset information of the iteration, to obtain predicted posture information of the second limb and interaction information between at least two second limbs of the second object. According to similar processing, the predicted posture information of each second limb in each iteration and the predicted interaction information between the at least two second limbs of the second object in each iteration may be obtained.

In each iteration, for each first limb, the computer device determines a difference between the limb posture information of the first limb and the predicted posture information of the corresponding second limb, and uses the difference as the single-limb constraint information between the first limb and the corresponding second limb. Similarly, the single-limb constraint information in each iteration is determined in each iteration.

For each iteration, limb interaction constraint information between the first object and the second object in the iteration is generated according to the limb interaction information and the predicted interaction information in the iteration. Similarly, the limb interaction constraint information in each iteration may be determined in each iteration.

For each second limb, the computer device screens out, from the candidate offset information in each iteration, target offset information corresponding to the second limb according to the single-limb constraint information and the limb interaction constraint information of the second limb in each iteration. The computer device corrects, based on the target offset information, the initial trajectory information of the second limb, to obtain the target trajectory information of the second limb.

In this embodiment, candidate offset information of each iteration is obtained. For each iteration, initial trajectory information of each second limb is pre-corrected based on the candidate offset information of the iteration, to obtain predicted posture information of each second limb and predicted interaction information between at least two second limbs. The initial trajectory information can be pre-corrected by using the candidate offset information, to predict a posture of each second limb in a second object after correction, and to predict an interaction between the second limbs after correction. In addition, pre-correction is performed in each iteration, and the posture of a single second limb of the second object and the interaction between multiple second limbs may be predicted repeatedly through multiple iterations. In each iteration, single-limb constraint information between a first limb and the second limb is determined according to limb posture information before migration and the predicted posture information after pre-correction, so that the generated single-limb constraint information enables a single second limb to maintain a posture consistent with that of a single first limb in consideration of a posture characteristic of a single limb when limb information is migrated. Limb interaction constraint information between a first object and the second object in each iteration is generated according to limb interaction information and the predicted interaction information of each iteration. The limb interaction constraint information enables multiple second limbs to obtain an interaction relationship between multiple first limbs, so that migration of trajectory information is more accurate.

In one embodiment, the operation of pre-correcting, for each iteration, the initial trajectory information of each second limb based on the candidate offset information of the iteration, to obtain the predicted posture information of each second limb and the predicted interaction information between the at least two second limbs includes:

pre-correcting, for each iteration, the initial trajectory information of each second limb based on the candidate offset information of the iteration, to obtain predicted trajectory information of each second limb; determining, based on the predicted trajectory information of each second limb, the predicted posture information of each second limb; and determining, based on the predicted trajectory information of each second limb, the predicted interaction information between the at least two second limbs.

In an iteration, candidate offset information is used to separately pre-correct the initial trajectory information of each second limb, to obtain predicted trajectory information of each second limb in the iteration. For each second limb, predicted posture information of the second limb is determined based on the predicted trajectory information of the second limb. Predicted interaction information between the at least two second limbs is determined based on the predicted trajectory information of each second limb.

In this embodiment, for each iteration, an initial start position and an initial end position of each second limb are corrected based on candidate offset information of the iteration, to obtain a predicted start position and a predicted end position corresponding to each second limb in the iteration, so that corresponding position information can be obtained based on correction under particular candidate offset information. According to the predicted start position and the predicted end position corresponding to each second limb in the iteration, respective posture information of the second limbs in the iteration can be accurately predicted, and interaction information between multiple second limbs can be accurately predicted.

In one embodiment, the operation of correcting, based on single-limb constraint information and limb interaction constraint information of each iteration, the initial trajectory information of each second limb, to obtain the target trajectory information of each second limb includes:
screening out, for each second limb, the target offset information of the second limb from the candidate offset information of each iteration based on the single-limb constraint information and the limb interaction constraint information of each iteration; and correcting, according to the target offset information of the second limb, the initial trajectory information of the second limb, to obtain the target trajectory information of the second limb.

For each iteration, the computer device determines, according to the limb interaction constraint information in the iteration and the single-limb constraint information of each second limb, target constraint information of each second limb in the iteration. For each second limb, a target iteration to which target constraint information satisfying a correction condition belongs is determined from the target constraint information of the second limb in each iteration, and candidate offset information in the target iteration is used as target offset information corresponding to the second limb.

In this embodiment, target offset information is screened by using single-limb constraint information and limb interaction constraint information in multiple iterations, so that the screened target offset information can satisfy constraints such as a single-limb constraint and a limb interaction constraint, and the determined target offset information can be more accurate. Initial trajectory information of a second limb is corrected according to the target offset information of the second limb, to obtain target trajectory information of the second limb, so that the corrected target trajectory information better conforms to characteristics of the second target limb, thereby improving trajectory migration accuracy.

In this embodiment, the first limb includes a start joint and an end joint, and the second limb includes a start joint and an end joint. The start joint of the first limb is a first start joint, and the end joint of the first limb is a first end joint. The second limb includes a start joint and an end joint, the start joint of the second limb is a second start joint, and the end joint of the second limb is a second end joint. The limb trajectory information includes a three-dimensional coordinate of the first start joint and a three-dimensional coordinate of the first end joint. The initial trajectory information includes an initial three-dimensional coordinate of the second start joint and an initial three-dimensional coordinate of the second end joint. The single-limb constraint information includes a single-joint chain constraint value. The limb interaction constraint information includes a joint chain interaction constraint value. The candidate offset information includes a candidate offset. The target offset information includes a target offset. Specifically, the target offset information may be a three-dimensional coordinate.

After calculating the single-joint chain constraint value and the joint chain interaction constraint value in each iteration, for each second limb, the computer device screens out the target offset of the second limb from the candidate offset in each iteration according to the single-joint chain constraint value and the joint chain interaction constraint value of the second limb in each iteration. The initial three-dimensional coordinate of the second end joint of the second limb is corrected based on the target offset of the second limb, to obtain a target three-dimensional coordinate of the second end joint. Alternatively, the initial three-dimensional coordinate of the second start joint may be corrected based on the target offset of the second limb, to obtain a target three-dimensional coordinate of the second start joint.

In this embodiment, the target offset may alternatively be a two-dimensional coordinate. To be specific, a coordinate on an x-axis and a coordinate on a y-axis are included, and a coordinate on a z-axis may be set to 0.

In this embodiment, respective limb trajectory information of at least two first limbs of a first object is obtained, and the at least two first limbs of the first object are in a one-to-one correspondence with at least two second limbs of a second object, to determine a second limb to which the limb trajectory information of the first limb needs to be migrated. The limb trajectory information is migrated from each first limb of the first object to the corresponding second limb of the second object, to preliminarily obtain initial trajectory information of each second limb. Limb posture information of each first limb and limb interaction information between the at least two first limbs are determined based on the limb trajectory information of each first limb, and a posture of each first limb and an interaction relationship between multiple first limbs can be determined. The respective initial trajectory information of the second limbs is pre-corrected, so that respective postures of the second limbs after pre-correction and an interaction relationship between the second limbs after pre-correction can be pre-estimated. Single-limb constraint information between each first limb and the corresponding second limb is determined according to the limb posture information of each first limb and the predicted posture information of the corresponding second limb, and the generated single-limb constraint information enables the second limb to obtain the posture of the first limb. Limb interaction constraint information between the first object and the second object is determined according to the limb interaction information and predicted interaction information. The limb interaction constraint information enables multiple second limbs to obtain an interaction relationship between multiple first limbs. The initial trajectory information of each second limb is corrected according to the individual single-limb constraint information and the limb interaction constraint information, to obtain target trajectory information of each second limb, so that the second limbs of the second object can obtain postures consistent with those of the first limbs of the first object, and an interaction relationship between the second limbs keeps consistency with an interaction relationship between the first limbs, thereby enabling migration of trajectory information to be more accurate.

In one embodiment, limb trajectory information of each first limb of a first object is obtained, and the limb trajectory information is migrated from each first limb of the first object to a corresponding second limb of a second object, to obtain initial trajectory information of each second limb. Candidate offset information is obtained, and predicted posture information of each second limb and predicted interaction information between multiple second limbs are determined based on the initial trajectory information of each second limb and the candidate offset information. For each first limb, single-limb constraint information between the first limb and the corresponding second limb is generated according to the limb posture information of the first limb and the predicted posture information of the corresponding second limb. Limb interaction constraint information between the first object and the second object is generated according to the limb interaction information and the predicted interaction information. The candidate offset information is adjusted based on a preset step, to obtain updated candidate offset information. A next iteration is entered. The updated candidate offset information is used as candidate offset information in the next iteration, and the operation of determining, based on the initial trajectory information of each second limb and the candidate offset information, predicted posture information of each second limb and predicted interaction information between multiple second limbs continues to be performed and stops when an iteration stop condition is satisfied, to obtain single-limb constraint information of each second limb in each iteration and limb interaction constraint information in each iteration. For each second limb, target offset information of the second limb is screened out from the candidate offset information in each iteration according to the single-limb constraint information and the limb interaction constraint information of the second limb in each iteration. The initial trajectory information of the second limb is corrected based on the target offset information of the second limb, to obtain target trajectory information of the second limb.

In one embodiment, the operation of migrating the limb trajectory information from each first limb of the first object to the corresponding second limb of the second object, to obtain initial trajectory information of each second limb includes:
determining a first limb length of each first limb, and determining a second limb length of each second limb; and adjusting, for each first limb, the limb trajectory information of the first limb according to the first limb length of the first limb and the second limb length of the corresponding second limb, to obtain the initial trajectory information of each second limb.

The first limb length is a length from the first start joint to the first end joint of the first limb. For example, the first limb is a lower limb, the first start joint is a hip joint, and the first end joint is an ankle joint. Then, the first limb length of the lower limb is a length from the hip joint to the ankle joint. The first limb is an upper limb, the first start joint is a shoulder joint, and the first end joint is a wrist joint. Then, the first limb length of the upper limb is a length from the shoulder joint to the wrist joint. The second limb length is a length from the second start joint to the second end joint of the second limb.

The computer device determines a first limb length of each first limb, and determines a second limb length of each second limb. For each first limb, the limb trajectory information of the first limb is adjusted according to the first limb length of the first limb and the second limb length of the corresponding second limb, to obtain adjusted trajectory information. Original limb trajectory information of the corresponding second limb is modified into the adjusted trajectory information, to obtain the initial trajectory information of the corresponding second limb.

In this embodiment, the limb trajectory information includes a three-dimensional coordinate of the first start joint and a three-dimensional coordinate of the first end joint. The initial trajectory information includes an initial three-dimensional coordinate of the second start joint and an initial three-dimensional coordinate of the second end joint. The computer device may determine a first limb length of a first limb, determine a second limb corresponding to the first limb, and determine a second limb length of the second limb. The computer device determines a ratio of the second limb length to the first limb length, and multiplies the ratio by limb trajectory information of the first limb to obtain initial trajectory information corresponding to the corresponding second limb. To be specific, the ratio is multiplied by the three-dimensional coordinate of the first start joint, to obtain the initial three-dimensional coordinate of the second start joint. The ratio is multiplied by the three-dimensional coordinate of the first end joint, to obtain the initial three-dimensional coordinate of the second end joint.

For example, trajectory migration is performed according to the following formula:

$$= \frac{\tilde{L}}{L} {X}_{k}$$

where [symbol] is the initial trajectory information of the second limb, Xₖ is the limb trajectory information of the first limb, L is the second limb length, and L is the first limb length.

In this embodiment, a first limb length of each first limb is determined, a second limb length of each second limb is determined, and for each first limb, limb trajectory information of the first limb is adjusted according to the first limb length of the first limb and the second limb length of the corresponding second limb, to migrate the limb trajectory information of the first limb to the corresponding second limb. In addition, migration is performed with reference to limb length information, so that the migrated trajectory information conforms to limbs of a second object in terms of proportions, thereby preliminarily obtaining initial trajectory information of each second limb.

In one embodiment, the initial trajectory information includes an initial start position and an initial end position of the second limb, and the predicted trajectory information includes a predicted start position and a predicted end position of the second limb.

The operation of determining, based on the predicted trajectory information of each second limb, the predicted posture information of each second limb includes: determining the second limb length of each second limb; and determining, for each second limb, the predicted posture information of the second limb based on the predicted start position, the predicted end position, and the second limb length of the second limb.

The operation of determining, based on the predicted trajectory information of each second limb, the predicted interaction information between the at least two second limbs includes: determining, according to the predicted start position and the predicted end position of each second limb, the predicted interaction information between the at least two second limbs.

The second limb includes a start joint and an end joint. The start joint of the second limb is a second start joint, and the end joint of the second limb is a second end joint. The initial trajectory information of the second limb includes an initial start position and an initial end position of the second limb. Then, the initial start position of the second limb is an initial start position of the second start joint, and the initial end position of the second limb is an initial end position of the second end joint.

The predicted trajectory information of the second limb includes a predicted start position and a predicted end position of the second limb. Then, the predicted start position of the second limb is a predicted start position of the second start joint, and the predicted end position of the second limb is a predicted end position of the second start joint. The initial start position is a position of the second start joint before pre-correction, and the predicted start position is a position of the second start joint after pre-correction. The initial end position is a position of the second end joint before pre-correction, and the predicted end position is a position of the second end joint after pre-correction.

For a current iteration, the computer device determines candidate offset information of the current iteration. In the current iteration, for the second start joint of each second limb, the computer device pre-corrects, based on the candidate offset information of the current iteration, the initial start position of the second start joint, to obtain a predicted start position of the second start joint in the current iteration. The computer device corrects, based on the candidate offset information of the current iteration, the initial end position of the second end joint, to obtain a predicted end position of the second end joint in the current iteration.

For each second limb, predicted posture information of the second limb in the current iteration is determined based on the predicted start position, the predicted end position, and the second limb length of the second limb in the current iteration. According to similar processing, respective predicted posture information of the second limbs in the current iteration may be obtained.

The computer device may determine, according to the predicted start position and the predicted end position of each second limb in the current iteration, predicted interaction information between multiple second limbs in the current iteration.

For other iteration processes, according to similar processing, the predicted posture information of each second limb and the predicted interaction information between the multiple second limbs in each iteration may be obtained.

In this embodiment, a second limb length of each second limb is determined. For each second limb in each iteration, a posture of each second limb after pre-correction in the iteration is accurately predicted based on a predicted start position, a predicted end position, and the second limb length of the second limb, and an interaction relationship between multiple second limbs after pre-correction is accurately predicted.

In one embodiment, the operation of determining, according to the predicted start position and the predicted end position corresponding to each second limb in the iteration, respective predicted posture information of the second limbs in the iteration and predicted interaction information between multiple second limbs includes:
determining respective second limb lengths of multiple second limbs of the second object, and determining, according to the predicted start position, the predicted end position, and the second limb length corresponding to each second limb in the iteration, predicted posture information corresponding to each second limb in the iteration; and determining, according to the respective predicted start positions and predicted end positions of the multiple second limbs in the iteration, predicted interaction information between the multiple second limbs in the iteration.

The computer device determines a second limb length of each second limb, determines, for each iteration, a distance between a predicted end position and a predicted start position corresponding to the same second limb in the iteration, and uses a ratio of the distance to the second limb length of the second limb as predicted posture information of the second limb. According to similar processing, the respective predicted posture information of the second limbs in each iteration may be obtained.

For each iteration, the computer device determines distances between respective predicted start positions of multiple second limbs and distances between respective predicted end positions of the multiple second limbs in the iteration, and determines, according to the distances, predicted interaction information between the multiple second limbs in the iteration.

For example, a predicted start position and a predicted end position of second limb j are Psⱼ^{k}, Peⱼ^{k}, and a second limb length of second limb j is Lⱼ. Then, predicted posture information vⱼ^{k} may be determined according to the following formula, where the predicted posture information vⱼ^{k} is expressed as a normalized vector:

$${v}_{j}^{k} = \frac{{Pe}_{j}^{k} - {Ps}_{j}^{k}}{{L}_{j}}$$

Two second limbs of the second object are 0 and 1, predicted end positions of second limb 0 and second limb 1 are Pes, Per, and predicted start positions of second limb 0 and second limb 1 are Ps₀^{k}, Ps₁^{k}. Then, a normalized vector von of second limb 0 and second limb 1 is defined as:

$${v}_{01}^{k} = \frac{{Pe}_{0}^{k} - {Pe}_{1}^{k}}{‖ {Ps}_{0}^{k} - {Ps}_{1}^{k} ‖}$$

where the normalized vector v₀₁^{k} is predicted interaction information between second limb 0 and second limb 1.

In this embodiment, respective second limb lengths of multiple second limbs of a second object are determined, and according to a predicted start position, a predicted end position, and the second limb length corresponding to each second limb in an iteration, predicted posture information corresponding to each second limb in the iteration may be accurately determined, to accurately construct a constraint between single limbs of different objects based on the predicted posture information of the single second limb. According to the respective predicted start positions and predicted end positions of the multiple second limbs in the iteration, predicted interaction information between the multiple second limbs in the iteration may be accurately determined, to construct an interaction constraint based on interaction information between the second limbs, so that target trajectory information after migration can be more accurately determined by using both a constraint of a single target limb and constraints of multiple target payments.

In one embodiment, the limb trajectory information includes a limb start position and a limb end position of the first limb. The operation of determining, based on the limb trajectory information of each first limb, limb posture information of each first limb and limb interaction information between the at least two first limbs includes:
determining the first limb length of each first limb; determining, for each first limb, the limb posture information corresponding to the first limb according to the limb start position, the limb end position, and the first limb length of the first limb; and
determining, according to the limb start position and the limb end position of each first limb, the limb interaction information between the at least two first limbs.

The computer device determines a limb start position of each first limb, and determines a limb end position of each first limb. The computer device determines a first limb length of each first limb. For each first limb, a distance between the limb end position and the limb start position of the first limb is determined, and a ratio of the distance to the first limb length of the first limb is used as limb posture information of the first limb.

The computer device determines distances between the respective limb start positions of multiple first limbs and distances between the respective limb end positions of the multiple first limbs, and determines, according to the distances, limb interaction information between the multiple first limbs.

In this embodiment, a first limb length of each first limb is determined, and for each first limb, limb posture information of the first limb can be accurately determined according to a limb start position, a limb end position, and the first limb length of the first limb. An interaction relationship between the first limbs can be accurately determined according to the limb start position and the limb end position of each first limb.

In one embodiment, the operation of correcting, based on the single-limb constraint information and the limb interaction constraint information, the initial trajectory information of each second limb, to obtain target trajectory information of each second limb includes:
determining a weight parameter of the single-limb constraint information and a weight parameter of the limb interaction constraint information; determining, according to the limb interaction constraint information, the single-limb constraint information, and the respective weight parameters, target constraint information corresponding to each second limb; and correcting, based on the target constraint information corresponding to each second limb, the initial trajectory information of each second limb, to obtain the target trajectory information of each second limb.

In this embodiment, a weight parameter of the single-limb constraint information and a weight parameter of the limb interaction constraint information are determined. For each iteration, target constraint information of each second limb in the iteration is determined according to the limb interaction constraint information in the iteration, the single-limb constraint information of each second limb, and the weight parameters. For each second limb, the initial trajectory information of the second limb is corrected based on the target constraint information of the second limb in each iteration, to obtain target trajectory information of the second limb.

The single-limb constraint information corresponds to the same weight parameter, and the limb interaction constraint information corresponds to the same weight parameter.

The computer device determines a weight parameter of the single-limb constraint information and a weight parameter of the limb interaction constraint information. For each iteration, weighted summation is performed according to the weight parameter of the single-limb constraint information, the weight parameter of the limb interaction constraint information, the limb interaction constraint information in the iteration, and the single-limb constraint information of a second limb in the iteration, to obtain target constraint information of the second limb in the iteration. According to similar processing, the target constraint information corresponding to each second limb in the iteration may be obtained.

For each second limb, target offset information of the second limb is screened out from the candidate offset information of each iteration based on the target constraint information of the second limb in each iteration. The initial trajectory information of the second limb is corrected according to the target offset information of the second limb, to obtain target trajectory information of the second limb. According to similar processing, the target trajectory information of each second limb may be obtained.

In this embodiment, a weight parameter of single-limb constraint information and a weight parameter of limb interaction constraint information are determined, to determine proportions of the single-limb constraint information and the limb interaction constraint information in a trajectory migration process. In multiple iterations, target constraint information of each second limb in an iteration is accurately determined according to the limb interaction constraint information in the iteration, the single-limb constraint information of each second limb, and the weight parameters, so that target offset information is determined in combination with the single-limb constraint information and the limb interaction constraint information, to accurately determine target trajectory information of each second limb.

In one embodiment, the limb trajectory information includes a limb start position and a limb end position of the first limb. The operation of determining a weight parameter of the single-limb constraint information and a weight parameter of the limb interaction constraint information includes:

determining, according to the limb start position and the limb end position of each first limb, the weight parameter of the single-limb constraint information; and determining, according to the weight parameter corresponding to the single-limb constraint information, the weight parameter corresponding to the limb interaction constraint information.

The limb trajectory information includes a limb start position and a limb end position of the first limb.

The computer device determines a limb start position of each first limb, and determines a limb end position of each first limb. The computer device determines distances between the respective limb end positions of multiple first limbs, determines distances between the respective limb start positions of the multiple first limbs, and determines, according to the distances, a weight parameter of the single-limb constraint information.

The computer device determines, according to the weight parameter corresponding to the single-limb constraint information, a weight parameter of the limb interaction constraint information. Further, a difference between a preset value and the weight parameter of the single-limb constraint information is used as the weight parameter of the limb interaction constraint information. The preset value is an empirical value set in advance.

In this embodiment, the operation of determining, according to the limb start position and the limb end position of each first limb, the weight parameter of the single-limb constraint information includes:

determining, according to the limb start position of each first limb, a Euclidean distance between the limb start positions; and determining, according to the Euclidean distance and a distance between the limb end positions, the weight parameter corresponding to the single-limb constraint information.

In this embodiment, a candidate weight parameter is determined according to respective limb start positions and limb end positions of multiple first limbs. A weight parameter of single-limb constraint information is determined from the candidate weight parameter and a preset value. A weight parameter of limb interaction constraint information is determined according to the preset value and the weight parameter of the single-limb constraint information. When the candidate weight parameter is less than the preset value, the candidate weight parameter is used as the weight parameter. When the candidate weight parameter is greater than the preset value, the preset value is used as the weight parameter.

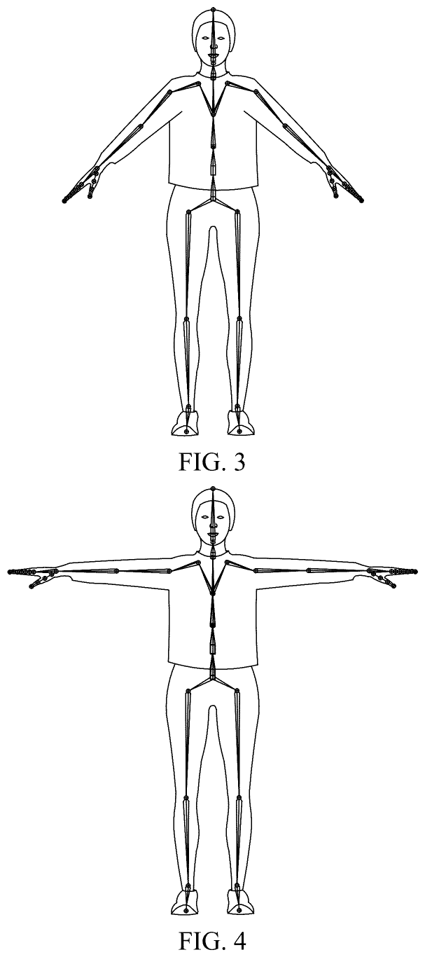

In this embodiment, respective limb start positions of multiple first limbs of a first object in a preset posture are determined, and a Euclidean distance between the limb start positions is determined. The preset posture may be an A-shaped posture A-Posture shown in FIG. 3, or may be a T-shaped posture T-Posture shown in FIG. 4.

For example, two first limbs of the first object are i, j, limb end positions of first limb i and first limb j are Peᵢ^{k}, Peⱼ^{k}, and a Euclidean distance between respective limb start positions of first limb i and first limb j is Lsᵢⱼ. Then, target constraint information C_{hc}^{k} corresponding to the first limb is:

$${C}_{hc}^{k} = {w}_{k} {C}_{sc}^{k} + ( 1 - {w}_{k} ) {C}_{mc}^{k}$$

where

$${w}_{k} = min ( 1 , \frac{‖ {Pe}_{i}^{k} - {Pe}_{j}^{k} ‖}{2 \cdot {Ls}_{ij}} ) ,$$

wₖ represents the weight parameter of single-limb constraint information C_{sc}^{k}, and (1−wₖ) represents the weight parameter of limb interaction constraint information C_{mc}^{k}.

In this embodiment, a weight parameter of single-limb constraint information is determined according to respective limb start positions and limb end positions of multiple first limbs, so that a proportion of the single-limb constraint information in a trajectory migration process can be determined based on the limb start positions and the limb end positions of the first limbs. A weight parameter of limb interaction constraint information is determined according to the weight parameter corresponding to the single-limb constraint information, to determine a proportion of multi-joint chain constraint information in the trajectory migration process, so that target trajectory information of a second limb can be more accurately calculated according to the single-limb constraint information and the limb interaction constraint information.

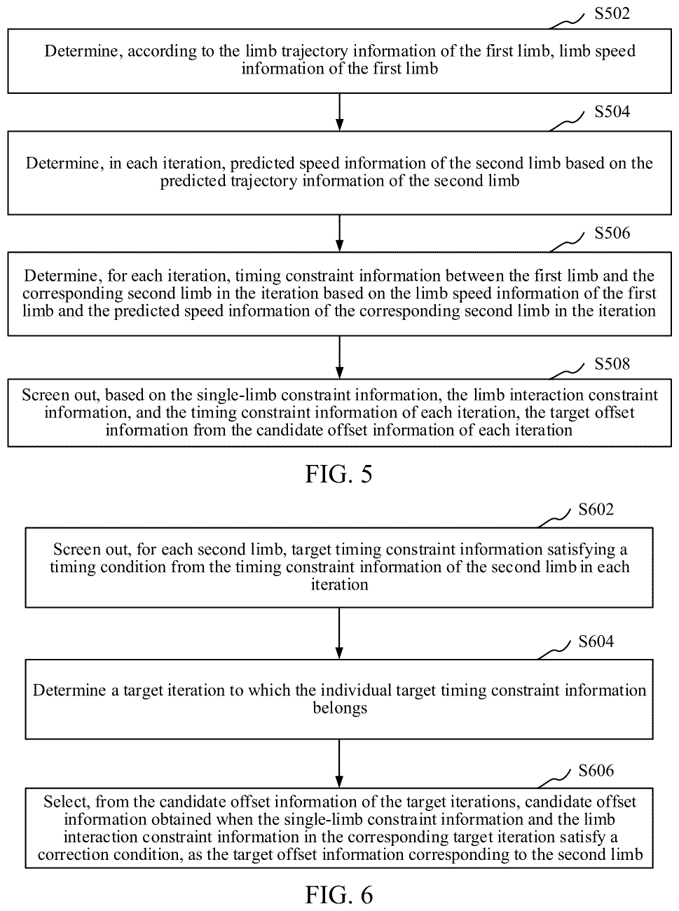

In one embodiment, as shown in FIG. 5, the method further includes the following operations.

Operation S502: Determine, according to the limb trajectory information of each first limb, limb speed information of each first limb.

The limb trajectory information includes limb end positions of the first limb in at least two moments. The operation of determining, according to the limb trajectory information of each first limb, limb speed information of each first limb includes:

determining, for each first limb, a first time relationship of the first limb in the at least two moments; and determining, according to the limb end positions of the first limb in the at least two moments and the first time relationship, the limb speed information of the first limb.

The at least two moments may be two consecutive moments. The first time relationship is a time difference between two moments for the first limb.

The first limb includes a first end joint, and the limb trajectory information includes limb end positions of the first end joint in at least two moments. For the first end joint of each first limb, a first time relationship of the first end joint in the at least two moments is determined. For each first limb, limb speed information of the first limb is determined according to the limb end positions of the end joint of the first limb in the at least two moments and the first time relationship.

In this embodiment, for each first limb, a first time relationship of the first limb in at least two moments is determined, and a time relationship of the same first limb in different moments can be determined. According to limb end positions of the first limb in at least two moments and the first time relationship, limb speed information of the first limb can be accurately determined.

Operation S504: Determine, in each iteration, predicted speed information of each second limb based on the predicted trajectory information of each second limb.

The predicted speed information is predicted information of a speed of the second limb.

In this embodiment, the initial trajectory information further includes initial end positions of the second limb in at least two moments, and the predicted trajectory information includes predicted end positions of the second limb in at least two moments.

The operation of determining, in each iteration, predicted speed information of each second limb based on the predicted trajectory information of each second limb includes:
determining, for each second limb in each iteration, a second time relationship of the second limb in the at least two moments; and determining, according to the predicted end positions of the second limb in the at least two moments and the second time relationship, the predicted speed information of the second limb.

In this embodiment, the initial trajectory information further includes initial end positions of the second end joint of the second limb in at least two moments, and the predicted trajectory information includes predicted end positions of the second end joint of the second limb in at least two moments. For the second end joint of each second limb in each iteration, a second time relationship of the second end joint in the at least two moments is determined. For each second limb, predicted speed information of the second limb is determined according to the predicted end positions of the second end joint of the second limb in the at least two moments and the second time relationship.

The at least two moments may be two consecutive moments. The second time relationship is a time difference between two moments for the second limb.

In this embodiment, respective predicted end positions of a second limb in two consecutive moments are determined, a distance between the two predicted end positions is determined, and predicted speed information of the second limb is determined according to a time difference between the two consecutive moments and the distance.

In this embodiment, for each second limb in each iteration, a second time relationship of the second limb in at least two moments is determined, and a time relationship of the same second limb in different moments can be determined. Predicted speed information of the second limb is accurately determined according to the predicted end positions of the second limb in the at least two moments and the second time relationship.

Operation S506: Determine, for each iteration, timing constraint information between each first limb and the corresponding second limb in the iteration based on the limb speed information of each first limb and the predicted speed information of the corresponding second limb in the iteration.

The timing constraint information is constraint information in timing when the limb trajectory information of the first limb is migrated to the second limb of the second object. Specifically, the timing constraint information may be constraint information in timing when the respective limb end positions of the first limb in the moments are migrated to the corresponding second limb.

The computer device generates, based on respective limb speed information of multiple first limbs and individual predicted speed information in an iteration, timing constraint information between each first limb and a corresponding second limb in the iteration.

The operation of screening out the target offset information from the candidate offset information of each iteration based on the single-limb constraint information and the limb interaction constraint information of each iteration includes operation S508.

Operation S508: Screen out, based on the single-limb constraint information, the limb interaction constraint information, and the timing constraint information of each iteration, the target offset information from the candidate offset information of each iteration.

For each second limb, the computer device determines, from candidate offset information of each iteration, target offset information of the second limb according to single-limb constraint information, limb interaction constraint information, and timing constraint information of the second limb in each iteration. Initial trajectory information of the second limb is corrected according to the target offset information of the second limb, to obtain target trajectory information of the second limb.

In this embodiment, the operation of determining, for each second limb, target offset information of the second limb from candidate offset information of each iteration according to single-limb constraint information, limb interaction constraint information, and timing constraint information of the second limb in each iteration includes:
determining, for each iteration, target constraint information of each second limb in the iteration according to the limb interaction constraint information in the iteration and the single-limb constraint information of each second limb; and determining, for each second limb, target offset information of the second limb from the candidate offset information of each iteration according to the target constraint information and the timing constraint information of the second limb in each iteration.

In this embodiment, the operation of determining, for each iteration, target constraint information of each second limb in the iteration according to the limb interaction constraint information in the iteration and the single-limb constraint information of each second limb includes:
determining a weight parameter of the single-limb constraint information and a weight parameter of the limb interaction constraint information; and determining, for each iteration, target constraint information of each second limb in the iteration according to the limb interaction constraint information in the iteration, the single-limb constraint information of each second limb, and the weight parameters.

In one embodiment, the operation of determining, for each second limb, target trajectory information of the second limb according to target constraint information and timing constraint information corresponding to the second limb in each iteration includes:
determining, for each second limb, target offset information corresponding to the second limb from candidate offset information of each iteration according to target constraint information and timing constraint information of the second limb in each iteration; and correcting, based on the target offset information corresponding to the second limb, corresponding initial trajectory information, to obtain target trajectory information of the second limb.

In this embodiment, the operation of determining, for each second limb, target offset information corresponding to the second limb from candidate offset information of each iteration according to target constraint information and timing constraint information of the second limb in each iteration includes:
screening out, for each second limb, target timing constraint information satisfying a timing condition from the timing constraint information of the second limb in each iteration; determining a target iteration to which the individual target timing constraint information belongs; and selecting, from the candidate offset information of the target iterations, candidate offset information obtained when the target constraint information in the corresponding target iteration satisfies a correction condition, as target offset information corresponding to the second limb.

In this embodiment, limb speed information of each first limb is determined according to limb trajectory information of each first limb. For each iteration, predicted speed information of each second limb in the iteration is determined based on initial trajectory information of each second limb and candidate offset information of the iteration, and timing constraint information between a first object and a second object in the iteration is generated based on the limb speed information of the multiple first limbs and the predicted speed information in the iteration, to constrain migration of limb trajectories in different moments by using the timing constraint information. For each second limb, target offset information is screened out from the candidate offset information of each iteration according to constraints such as single-limb constraint information, limb interaction constraint information, and timing constraint information of the second limb in each iteration, so that the determined target offset information better conforms to characteristics of the second limb, thereby improving trajectory migration accuracy.

In one embodiment, the first limb is connected to a first foot of the first object, and the second limb is connected to a second foot of the second object. The operation of determining, for each iteration, timing constraint information between each first limb and the corresponding second limb in the iteration based on the limb speed information of each first limb and the predicted speed information of the corresponding second limb in the iteration includes:
determining a first foot length of each first foot, and determining a second foot length of each second foot; and determining, for each iteration, the timing constraint information between each first limb and the corresponding second limb in the iteration based on the limb speed information, the first foot length, the second foot length, and the predicted speed information in the iteration.

The first limb is a lower limb of the first object, and the second limb is a lower limb of the second object. The first object has at least two first limbs and at least two first feet. The at least two first limbs are in a one-to-one correspondence with the at least two first feet. To be specific,
one first limb is connected to one first foot. The second object has at least two second limbs and at least two second feet. The at least two second limbs are in a one-to-one correspondence with the at least two second feet. To be specific, one second limb is connected to one second foot.

In this embodiment, a hip joint of the first object is used as a first start joint of the first limb, and an ankle joint of the first object is used as a first end joint. A hip joint of the second object is used as a second start joint of the second limb, and an ankle joint of the second object is used as a second end joint.

The computer device determines a length of each first foot, i.e. a first foot length. For each first limb, the computer device determines a first ratio of the limb speed information of the first limb to the first foot length. To be specific, a first ratio corresponding to the first limb is obtained.

The computer device determines a length of each second foot, i.e. a second foot length. In an iteration, a second ratio of the predicted speed information of each second limb in the iteration to the corresponding second foot length is determined. To be specific, a second ratio corresponding to each second limb in the iteration is obtained.

The computer device determines a difference between the first ratio of the first limb and the second ratio of the corresponding second limb in the current iteration, and uses the difference as timing constraint information between the first limb and the corresponding second limb in the current iteration. According to similar processing, the timing constraint information between each second limb and the corresponding first limb in each iteration may be obtained.

In this embodiment, a first foot length of each first foot and a second foot length of each second foot are determined, to generate timing constraint information between each first limb and a corresponding second limb in an iteration based on limb speed information, each first foot length, each second foot length, and predicted speed information in the iteration, so that migration of limb trajectories in different moments can be constrained by using the timing constraint information, and postures and interaction relationships of the first limb in different moments can be accurately migrated to the second limb in corresponding moments, thereby avoiding problems such as slipping of the migrated second limb caused by a timing disorder and further improving migration accuracy.

In one embodiment, the operation of determining, for each second limb, target trajectory information of the second limb according to single-limb constraint information, limb interaction constraint information, and timing constraint information of the second limb in each iteration includes:
determining, for each second limb, target offset information corresponding to the second limb from candidate offset information of each iteration according to the single-limb constraint information, the limb interaction constraint information, and the timing constraint information of the second limb in each iteration; and correcting, based on the target offset information corresponding to the second limb, corresponding initial trajectory information, to obtain target trajectory information of the second limb.

For each iteration, the computer device determines, based on the limb interaction constraint information in the iteration and the single-limb constraint information corresponding to each second limb, target constraint information corresponding to each second limb in the iteration. For each second limb, target offset information corresponding to the second limb is determined from candidate offset information of each iteration according to target constraint information and timing constraint information of the second limb in each iteration. Corresponding initial trajectory information is corrected based on the target offset information corresponding to the second limb, to obtain target trajectory information of the second limb.

In this embodiment, the initial trajectory information includes an initial end position of the second limb. The initial end position of the second limb is corrected based on the target offset information corresponding to the second limb, to obtain a target end position of the second limb. The target end position is used as target trajectory information.

In this embodiment, for each second limb, target offset information corresponding to the second limb is determined from candidate offset information in each iteration according to single-limb constraint information, limb interaction constraint information, and timing constraint information of the second limb in each iteration, so that the determined target offset information can satisfy constraints such as a single-joint chain constraint, a multi-joint chain constraint, and a timing constraint, and the determined target offset information can be more accurate. Corresponding initial trajectory information is corrected based on the target offset information corresponding to the second limb, to obtain target trajectory information of the second limb, so that the corrected target trajectory information better conforms to characteristics of the second limb, thereby improving trajectory migration accuracy.

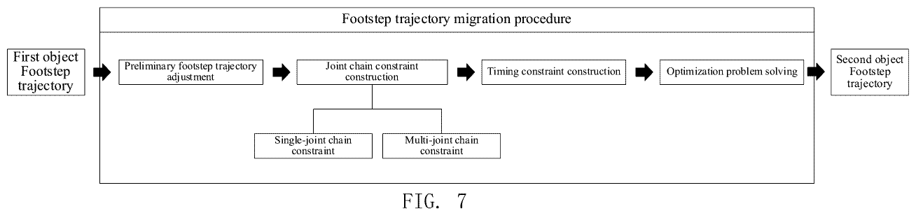

In one embodiment, as shown in FIG. 6, the operation of screening out, based on the single-limb constraint information, the limb interaction constraint information, and the timing constraint information of each iteration, the target offset information from the candidate offset information of each iteration includes:

Operation S602: Screen out, for each second limb, target timing constraint information satisfying a timing condition from the timing constraint information of the second limb in each iteration.

The computer device obtains a preset timing condition. For each second limb, the computer device screens out, from the timing constraint information of the second limb in each iteration, timing constraint information satisfying the timing condition. The screened timing constraint information is target timing constraint information.

In this embodiment, the timing condition may be specifically a timing threshold, and the timing constraint information may include a timing constraint value. The computer device compares the timing constraint value of the second limb in each iteration with the timing threshold, and screens out a timing constraint value less than the timing threshold as a target timing constraint value. For example, the timing threshold may be 10⁻⁶, and a timing constraint value less than 10⁻⁶ is screened out as the target timing constraint value.

Operation S604: Determine a target iteration to which the individual target timing constraint information belongs.

For individual target timing constraint information of each second limb, the computer device determines a target iteration to which the target timing constraint information belongs, to obtain a target iteration corresponding to the second limb. According to similar processing, the target iteration corresponding to each second limb may be obtained.

Further, the computer device determines target timing constraint values corresponding to the second limbs, and determines an iteration to which each target timing constraint value belongs.

Operation S606: Select, from the candidate offset information of the target iterations, candidate offset information obtained when the single-limb constraint information and the limb interaction constraint information in the corresponding target iteration satisfy a correction condition, as the target offset information corresponding to the second limb.

The correction condition is a condition used for screening out the target offset information from the candidate offset information of the multiple target iterations.

For each iteration, the computer device determines, based on the limb interaction constraint information in the iteration and the single-limb constraint information corresponding to each second limb, target constraint information corresponding to each second limb in the iteration.

The computer device selects, from the candidate offset information of the target iterations, candidate offset information obtained when the target constraint information in the corresponding target iteration satisfies a correction condition, and uses the selected candidate offset information as target offset information corresponding to the second limb.

In this embodiment, the single-limb constraint information includes a single-joint chain constraint value, the limb interaction constraint information includes a joint chain interaction constraint value, and the target constraint information includes a target constraint value. The correction condition may be specifically that the target constraint value in the target iterations is minimum. The computer device may select a minimum target constraint value from the target constraint values of the second limb in the target iterations. The candidate offset information in the target iteration to which the minimum target constraint value belongs is used as the target offset information corresponding to the second limb.

In this embodiment, timing constraint information is used as a constraint condition that needs to be satisfied. For each second limb, target timing constraint information satisfying a timing condition is screened out from the timing constraint information of the second limb in each iteration, so that candidate offset information when the timing constraint information satisfies the condition can be screened out, and problems such as slipping after migration caused by a timing disorder can be effectively avoided. A target iteration to which the individual target timing constraint information belongs is determined. Candidate offset information when single-limb constraint information and limb interaction constraint information in the corresponding target iteration satisfy a correction condition is selected from candidate offset information of the target iterations as target offset information corresponding to the second limb, to screen the selected candidate offset information again based on timing condition-based screening, so that the target offset information when the single-limb constraint information and the limb interaction constraint information satisfy the correction condition can be screened out, and an initial trajectory of the second limb is corrected by using the target offset information, to obtain an accurate target trajectory.

In one embodiment, the first limb includes a first joint chain, where the first joint chain is formed by connecting multiple joints of the first object and parts between the multiple joints. The second limb includes a second joint chain, where the second joint chain is formed by connecting multiple joints of the second object and parts between the multiple joints. The single-limb constraint information is constraint information between the first joint chain and the second joint chain. The limb interaction constraint information is constraint information between a first interaction relationship and a second interaction relationship, where the first interaction relationship is an interaction relationship between at least two first joint chains, and the second interaction relationship is an interaction relationship between at least two second joint chains.

The first object has multiple first limbs. One first limb has multiple joints and at least one part connecting the multiple joints. The multiple joints of the first limb and the parts between the multiple joints are connected to form the first joint chain. The multiple joints of the first limb include a first start joint and a first end joint.

The second object has multiple second limbs. One second limb has multiple joints and at least one part connecting the multiple joints. The multiple joints of the second limb and the parts between the multiple joints are connected to form the second joint chain. The multiple joints of the second limb include a second start joint and a second end joint.

The single-limb constraint information is single-joint chain constraint information. The single-joint chain constraint information is constraint information about a posture of a single joint chain. When limb trajectory information is migrated, the posture of the first joint chain is migrated to the second joint chain, so that the second joint chain has the posture of the first joint chain. The single-joint chain constraint information is configured for constraining the migrated posture, so that the posture migrated to the second joint chain can conform to the second joint chain.

The limb interaction constraint information is multi-joint chain interaction constraint information. The multi-joint chain interaction constraint information is constraint information about an interaction relationship of joint chains. When the limb trajectory information is migrated, a first interaction relationship between two first joint chains is migrated to two second joint chains, to obtain a second interaction relationship between the two second joint chains. The multi-joint chain interaction constraint information is configured for constraining the migrated interaction relationships, so that migration of limb trajectories is more accurate in consideration of cooperation between the two joint chains during migration.

In one embodiment, a trajectory information processing method is provided, which is applied to a computer device. The method includes:
obtaining respective limb start positions and limb end positions of multiple first limbs of a first object; determining a first limb length of each first limb and respective second limb lengths of multiple second limbs of a second object; and adjusting, for each first limb, the limb start position and the limb end position of the first limb according to the first limb length of the first limb and the corresponding second limb length, to generate an initial start position and an initial end position corresponding to the corresponding second limb.

For each first limb, limb posture information corresponding to the first limb is determined according to the limb start position, the limb end position, and the first limb length of the first limb. Limb interaction information between multiple first limbs is determined according to the respective limb start positions and limb end positions of the multiple first limbs.

Candidate offset information of each iteration is obtained, and for each iteration, the initial start position and the initial end position of each second limb are corrected based on the candidate offset information of the iteration, to obtain a predicted start position and a predicted end position corresponding to each second limb in the iteration.

According to the predicted start position, the predicted end position, and the second limb length corresponding to each second limb in the iteration, predicted posture information corresponding to each second limb in the iteration is determined. According to the respective predicted start positions and predicted end positions of the multiple second limbs in the iteration, predicted interaction information between the multiple second limbs in the iteration is determined.

For each first limb in each iteration, single-limb constraint information between the first limb and the corresponding second limb is generated according to the limb posture information of the first limb and the predicted posture information of the corresponding second limb. Limb interaction constraint information between the first object and the second object in each iteration is generated according to the limb interaction information between the multiple first limbs and the predicted interaction information in each iteration.

According to the respective limb start positions and limb end positions of the multiple first limbs, a weight parameter of the single-limb constraint information is determined. According to the weight parameter corresponding to the single-limb constraint information, a weight parameter corresponding to the limb interaction constraint information is determined. For each iteration, target constraint information corresponding to each second limb in the iteration is determined according to the limb interaction constraint information in the iteration, the single-limb constraint information corresponding to each second limb, and the weight parameters.

For each iteration, predicted speed information of each second limb in the iteration is determined based on the predicted end position of each second limb and the candidate offset information of the iteration.

First foot lengths of feet respectively connected to the multiple first limbs and second foot lengths of feet respectively connected to the multiple second limbs are determined. Timing constraint information between the first object and the second object in the iteration is generated based on the individual limb speed information, each first foot length, each second foot length, and the individual predicted speed information in the iteration.

For each second limb, target timing constraint information satisfying a timing condition is screened out from the timing constraint information of the second limb in each iteration. A target iteration to which the individual target timing constraint information belongs is determined. Candidate offset information obtained when the target constraint information in the corresponding target iteration satisfies a correction condition is selected from the candidate offset information of the target iterations as target offset information corresponding to the second limb.

Corresponding initial trajectory information is corrected based on the target offset information corresponding to the second limb, to obtain target trajectory information of the second limb.

In one embodiment, a trajectory information processing method is provided, which is applied to an animation retargeting scene. Animation retargeting is intended to migrate an animation resource of an existing object to a new object. Based on this technology, when a new animation object is completely manufactured, an animation does not need to be additionally manufactured for the new animation object, but an existing animation may be reused at zero costs. The animation retargeting is a necessary part of a mainstream animation production procedure. The trajectory information processing method in this embodiment may replace any existing footstep trajectory migration method for animation retargeting, and is directly combined with an existing animation production procedure. In terms of a specific application, the trajectory information processing method in this embodiment may be applied to any scene in which an animation needs to be reused, for example, a three-dimensional game, a meta-universe product, virtual live streaming, or film and television media, but is not limited thereto. A footstep trajectory of an animation sequence may be migrated between any objects without an animator making a corresponding animation for each object, thereby implementing zero-cost reuse of animation materials.

The animation sequence is logic/data for driving an object to move and achieve a dynamic effect, and is widely applied to fields such as games, film and television, for example, object actions in a three-dimensional game. The “animation sequence” in this embodiment may be a physical animation of an object in a 3D scene.

The animation retargeting is migration of the animation sequence between different objects. For example, there is an animation sequence of object A and a model of object B. The animation retargeting is migrating the animation sequence of object A to B, and adapting to an object characteristic of object B while keeping action features such as joint bending and action trend of object A. The object characteristic is, for example, a framework topology and a model shape.

The footstep trajectory, i.e. limb trajectory information, is a trajectory formed by a footstep position of each frame of an object in a given animation sequence. A human object is used as an example. A target limb is a lower limb of the human object, and the footstep position is a position sequence of an ankle joint. A first object is a character of a to-be-migrated animation, i.e. object A in an animation retargeting definition. An original animation, i.e. the limb trajectory information, is a to-be-migrated animation sequence, i.e. an animation sequence of object A in the animation retargeting definition. A second object is a target of animation migration, i.e. object B in the animation retargeting definition.

A binding posture is a preset posture. When a modeler produces a three-dimensional model, a default posture used by a binding skeleton is generally an A-shaped posture A-Posture or a T-shaped posture T-Posture, as shown in FIG. 3 and FIG. 4.

An overall procedure of a trajectory information processing method in this embodiment is shown in FIG. 7. An input is a footstep trajectory of a first object, and an output is a footstep trajectory of a second object under the same action. The footstep trajectory of the first object may be obtained by reading an offline animation file in an .fbx format or by using a real-time animation stream. The overall procedure is divided into four operations. 1. Preliminarily adjust a footstep trajectory of an original animation. 2. Construct a joint chain constraint for a lower limb of an object. 3. Construct a timing constraint for the footstep trajectory. 4. Construct and solve a migration problem with constraints, and output a footstep trajectory of a second object.

In this embodiment, a wavy line is added to a corresponding symbol of the first object to represent a corresponding physical quantity of the second object. For example, L represents a lower limb length of the first object, and L represents a lower limb length of the second object.

### 1. Preliminarily Adjust a Footstep Trajectory of an Original Animation

The original animation is divided into multiple frames according to duration, and the footstep trajectory of the original animation is adjusted according to a body ratio of the first object to the second object. To be specific, the lower limb length of the first object is denoted as L. The footstep trajectory of the first object is Xₖ, including a three-dimensional coordinate of a footstep of the first object in each frame, i.e. a limb start position, and may include a limb end position. The footstep trajectory of the second object is [symbol] , including an initial three-dimensional coordinate of a footstep of the second object in each frame, i.e. an initial start position, and may include an initial end position. The footstep trajectory [symbol] of the second object may be calculated by using the following formula:

$$= \frac{\tilde{L}}{L} {X}_{k}$$

For example, the footstep trajectory Xₖ of the first object includes the three-dimensional coordinate of the footstep of the first object in frame k, and the initial three-dimensional coordinate corresponding to the footstep of the second object in frame k may be obtained by using the foregoing formula.

In this operation, the footstep trajectory of the original animation is roughly adjusted, and the obtained footstep trajectory may be adapted to a body ratio of the second object, and is used as an input of a subsequent operation.

### 2. Construct a Joint Chain Constraint of a Lower Limb of an Object

The lower limb of the object is modeled into a data format of a joint chain, and footstep trajectory information of the original animation is encoded into a constraint of the joint chain, including the following operations. 1) Encode a posture of a single lower limb by using a single-joint chain constraint. 2) Encode interaction information between lower limbs by using a multi-joint chain constraint. Specific processes are as follows.

### 1) Encode a Posture of a Single Lower Limb by Using a Single-Joint Chain Constraint

A three-dimensional coordinate Xₖ of a footstep of a first object in frame k of an animation may include three-dimensional coordinates of a start and end (i.e. crotch and ankle joints) of joint chain j of a lower limb of the first object, i.e. Psⱼ^{k}, Peⱼ^{k}. An initial three-dimensional coordinate [symbol] corresponding to a footstep of a second object in frame k includes an initial three-dimensional coordinate of a start of joint chain j of a lower limb of the second object and an initial three-dimensional coordinate of an end. According to candidate offset pair, the initial three-dimensional coordinates of the start and the end corresponding to the footstep of the second object in frame k are corrected to obtain respective predicted three-dimensional coordinates, i.e. a predicted start position and a predicted end position, of the start and the end corresponding to the footstep of the second object in frame k.

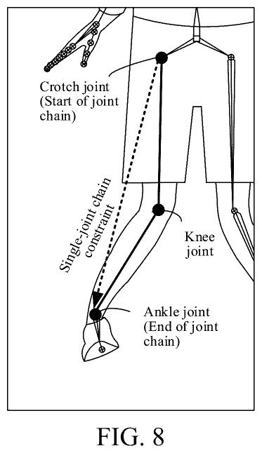

Considering a posture of a single lower limb, the posture is encoded as a normalized vector pointing from a start to an end of a lower limb joint chain. An example in which the first object and the second object are both human objects is used. The joint chain includes several joint nodes on the human object that have a parent-child relationship and corresponding skeletons. As shown in FIG. 8, a crotch joint, a knee joint, an ankle joint, and skeletons between the joints are organized into the joint chain. Transformation such as translation and rotation of a joint may be adjusted to drive skeleton motion on the joint chain, thereby driving motion of the entire object.

The three-dimensional coordinates of the start and the end (i.e. the crotch and ankle joints) of joint chain j in frame k of the animation are denoted as Psⱼ^{k}, Peⱼ^{k}. A sum of lengths (i.e. lengths connecting the crotch joint, the knee joint, and the ankle joint) of the skeletons included in joint chain j is Lⱼ. The corresponding normalized vector vⱼ^{k} is:

$${v}_{j}^{k} = \frac{{Pe}_{j}^{k} - {Ps}_{j}^{k}}{{L}_{j}}$$

According to the formula, limb posture information vⱼ^{k} corresponding to the lower limb of the first object in frame k may be obtained. According to the predicted three-dimensional coordinate of the start and the predicted three-dimensional coordinate of the end of joint chain j of the second object, predicted posture information \tilde{v}ⱼ^{k} corresponding to the lower limb of the second object in frame k may be obtained.

The single-joint chain constraint is intended to keep postures of single lower limbs of the first object and the second object consistent. The number of joint chains of the lower limb of the object is denoted as M. A single-joint chain constraint C_{sc}^{k} in frame k of the animation is defined as:

$${C}_{sc}^{k} = {\sum }_{j = 0}^{M} ‖ {v}_{j}^{k} - {\tilde{v}}_{j}^{k} ‖$$

### 2) Encode Interaction Information Between Lower Limbs by Using a Multi-Joint Chain Constraint

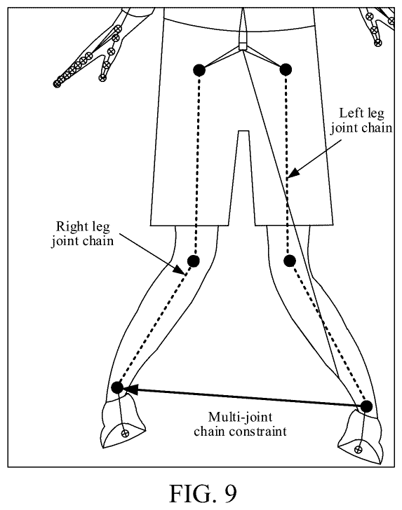

The multi-joint chain constraint is a joint chain interaction constraint. Considering interaction information between lower limbs, the interaction information is encoded as a normalized vector between joint chain ends of different lower limbs. As shown in FIG. 9, a human object is used as an example. Left and right leg joint chains of a first object in frame k of an original animation are joint chain i and joint chain j. Positions of end joints (i.e. ankle joints) thereof are Peᵢ^{k}, Peⱼ^{k}. Positions of start joints (i.e. crotch joints) of the two joint chains in a binding posture are Psᵢ^{k}, Psⱼ^{k}. Then, a normalized vector between joint chain i and joint chain j of the first object is defined as:

$${v}_{ij}^{k} = \frac{{Pe}_{i}^{k} - {Pe}_{j}^{k}}{‖ {Ps}_{i}^{k} - {Ps}_{j}^{k} ‖}$$

For example, left and right leg joint chains of a first object in frame k of an original animation are joint chain 0 and joint chain 1. Positions of end joints thereof are Pe₀^{k}, Pe₁^{k}. Positions of start joints of the two joint chains in a binding posture are Ps₀, Ps₁. Then, a normalized vector between joint chain 0 and joint chain 1 of the first object is defined as:

$${v}_{01}^{k} = \frac{{Pe}_{0}^{k} - {Pe}_{1}^{k}}{‖ {Ps}_{0}^{k} - {Ps}_{1}^{k} ‖}$$

The normalized vector between joint chain 0 and joint chain 1 of the first object is limb interaction information between joint chain 0 and joint chain 1 of the first object. According to similar processing, predicted interaction information \tilde{v}₀₁^{k} between joint chain 0 and joint chain 1 of a second object may be obtained.

The foregoing normalized vectors may be obtained for all joint chains of lower limbs of the object. The number of joint chains of the lower limbs of the object is denoted as M. A multi-joint chain constraint C_{mc}^{k} in frame k of the animation is defined as:

$${C}_{mc}^{k} = {\sum }_{i = 0}^{M} {\sum }_{j = 0}^{M} ‖ {v}_{ij}^{k} - {\tilde{v}}_{ij}^{k} ‖ ( i \neq j )$$

### 3) Combine the Single-Joint Chain Constraint and the Multi-Joint Chain Constraint

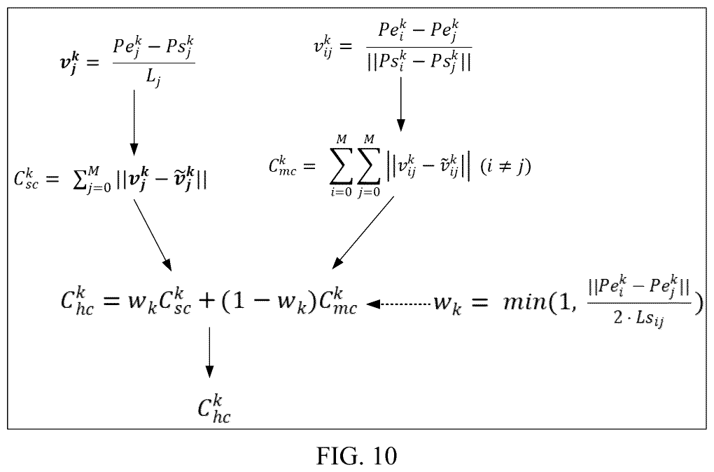

As shown in FIG. 10, according to actions of a lower limb of an object, the foregoing two types of lower limb semantics are adaptively combined. Three-dimensional coordinates between end joints of joint chain i and joint chain j in frame k of an original animation are Peᵢ^{k}, Peⱼ^{k}, and a Euclidean distance between start joints in a binding posture of an original person is Lsᵢⱼ. A target constraint C_{hc}^{k} obtained after combination in frame k of the animation is defined as:

$${C}_{hc}^{k} = {w}_{k} {C}_{sc}^{k} + ( 1 - {w}_{k} ) {C}_{mc}^{k}$$

The weight parameter

$${w}_{k} = min ( 1 , \frac{‖ {Pe}_{i}^{k} - {Pe}_{j}^{k} ‖}{2 \cdot {Ls}_{ij}} ) .$$

### 3. Construct a Footstep Trajectory Timing Constraint

The construction of a timing constraint for the footstep trajectory is intended to keep dynamic information of the footstep trajectory of the original person, to avoid slipping. A speed of an end joint of lower limb joint chain j in frame k of the original animation is velⱼ^{k}, and a foot length of the first object is L_{f} (the foot length of a human object is a Euclidean distance between an ankle joint and a tiptoe joint). A timing constraint Cₜ^{k} in frame k of the animation is defined as:

$${C}_{t}^{k} = - \frac{{vel}_{j}^{k}}{{L}_{f}}$$

where the foot length of the second object is \tilde{L}_{f}, and the speed of the end joint of lower limb joint chain j of the second object in frame k is [symbol] . [symbol] is obtained by calculation according to a predicted three-dimensional coordinate of the end joint in frame k and a predicted three-dimensional coordinate of the end joint in an adjacent frame.

### 4. Construct and Solve a Migration Problem

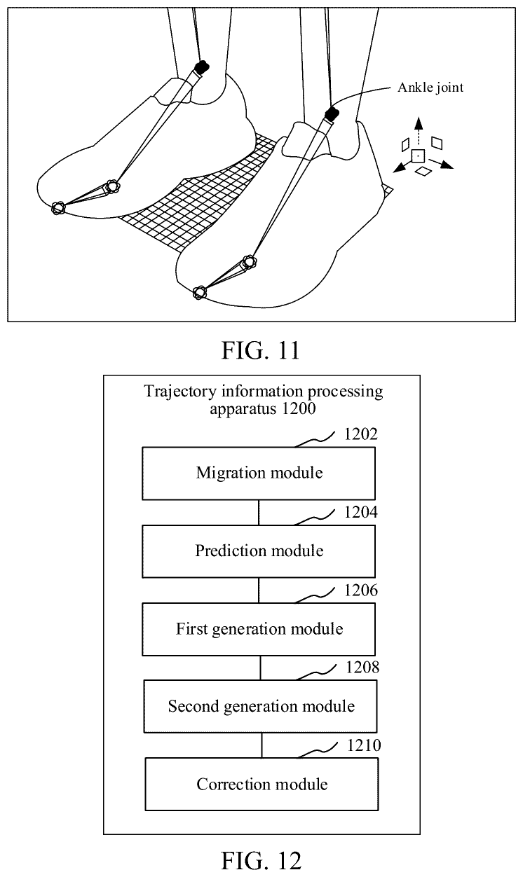

A migration problem with constraints is constructed based on a single-joint chain constraint, a double-joint chain constraint, and a timing constraint, to obtain a footstep trajectory of a target person by solving. An offset is an offset of an initial footstep trajectory of the second object in a horizontal plane direction. A human object is used as an example. As shown in FIG. 11, an offset is an offset of left and right ankle joints (black parts) in directions of a horizontal axis and a vertical axis.

In a migration process, to avoid an apparent defect such as slipping, the timing constraint in operation 3 is set to a hard constraint. To be specific, a solution result needs to satisfy the constraint. The joint chain constraint in operation 2 has a relatively low priority and is set to a soft constraint. To be specific, the soft constraint is satisfied as far as possible on the premise that the hard constraint is satisfied. In frame k of the animation, a constraint definition of a migration problem is specifically as follows.

$$min \{ {C}_{hc}^{k} \} \\ s . t . {C}_{t}^{k} < {10}^{- 6}$$

A local migration algorithm COBYLA is used for migration solving, and a convergence condition is that a change amount between offsets in two adjacent iterations is less than or equal to 10⁻⁵. To be specific, when a difference between candidate offsets used in two adjacent iterations is less than 10⁻⁵, the iteration is stopped. The candidate offsets used in the iterations are different. For a processing procedure of each iteration, refer to operation 1 and operation 4, to obtain a target constraint value C_{hc}^{k} and a timing constraint value Cₜ^{k} in each iteration.

After the target constraint value C_{hc}^{k} and the timing constraint value Cₜ^{k} in each iteration are obtained, a timing constraint value less than 10⁻⁶ is screened out from the respective timing constraint values Cₜ^{k}, and the iteration to which the screened timing constraint value belongs is determined. The target constraint values C_{hc}^{k} of the iterations are determined, a minimum target constraint value C_{hc}^{k} is selected from the target constraint values C_{hc}^{k} of the iterations, and a candidate offset in the iteration to which the minimum target constraint value C_{hc}^{k} belongs is used as a target offset, to obtain an offset of the footstep trajectory of the second object in the horizontal plane direction. The target offset is applied to the footstep trajectory of the second object, and a final footstep trajectory of the second object is outputted.

In this embodiment, another migration solving mode, including but not limited to a gradient-based SLSQP algorithm or a global migration-based StoGO algorithm, may be used for replacing the COBYLA algorithm.

The trajectory information processing method in this embodiment is a footstep trajectory migration method for animation retargeting. By modeling a leg by using a joint chain, footstep trajectory information of an original animation is encoded into constraint information of the joint chain. A migration problem with constraints is constructed based on the information, a footstep trajectory of a target person is obtained through solving, and the problem of footstep trajectory migration in the animation retargeting is solved.

The trajectory information processing method in this embodiment provides a constraint information construction solution based on a single-joint chain and a double-joint chain, and an adaptive constraint combination mode, to simultaneously encode limb posture and limb interaction information of an original animation, and output a footstep trajectory reserving a limb posture of the original animation and an interaction relationship between the lower limbs. In addition, the proposed timing constraint may avoid problems such as slipping existing in a footstep trajectory migration process. The trajectory information processing method is applicable to footstep trajectory migration between objects having any number of joints of lower limbs, and has strong generalization and robustness.

The operations in the flowcharts involved in the foregoing embodiments are displayed in sequence based on indication of arrows, but the operations are not necessarily performed sequentially according to a sequence indicated by the arrows. Unless otherwise explicitly specified in the present disclosure, execution of the operations is not strictly limited, and the operations may be performed in other sequences. Moreover, at least some of the operations in flowcharts in the above embodiment may include multiple sub-operations or multiple stages. The operations or stages are not necessarily performed at the same moment but may be performed at different moments. Execution of the operations or stages is not necessarily sequentially performed, but may be performed alternately with other operations or at least some operations or stages of other operations.

Based on the same inventive concept, embodiments of the present disclosure further provide a trajectory information processing apparatus for implementing the foregoing trajectory information processing method. Implementation solutions provided by the apparatus for solving problems are similar to the implementation solutions described in the foregoing method. Therefore, for specific limitations in one or more trajectory information processing apparatus embodiments provided below, refer to the limitations on the trajectory information processing method in the foregoing descriptions. Details are not described herein again.

In one embodiment, as shown in FIG. 12, a trajectory information processing apparatus 1200 is provided, including: a migration module 1202, a prediction module 1204, a first generation module 1206, a second generation module 1208, and a correction module 1210.

The migration module 1202 is configured to: obtain respective limb trajectory information of at least two first limbs of a first object, where the at least two first limbs of the first object are in a one-to-one correspondence with at least two second limbs of a second object; and migrate the limb trajectory information from each first limb of the first object to the corresponding second limb of the second object, to obtain initial trajectory information of each second limb.

The prediction module 1204 is configured to: determine, based on the limb trajectory information of each first limb, limb posture information of each first limb and limb interaction information between the at least two first limbs; and pre-correct the initial trajectory information of each second limb, to obtain predicted posture information of each second limb and predicted interaction information between the at least two second limbs.

The first generation module 1206 is configured to determine, according to the limb posture information and the predicted posture information, single-limb constraint information between each first limb and the corresponding second limb.

The second generation module 1208 is configured to determine, according to the limb interaction information and the predicted interaction information, limb interaction constraint information between the first object and the second object.

The correction module 1210 is configured to correct, based on the individual single-limb constraint information and the limb interaction constraint information, the initial trajectory information of each second limb, to obtain target trajectory information of each second limb.

In this embodiment, respective limb trajectory information of at least two first limbs of a first object is obtained, and the at least two first limbs of the first object are in a one-to-one correspondence with at least two second limbs of a second object, to determine a second limb to which the limb trajectory information of the first limb needs to be migrated. The limb trajectory information is migrated from each first limb of the first object to the corresponding second limb of the second object, to preliminarily obtain initial trajectory information of each second limb. Limb posture information of each first limb and limb interaction information between the at least two first limbs are determined based on the limb trajectory information of each first limb, and a posture of each first limb and an interaction relationship between multiple first limbs can be determined. The respective initial trajectory information of the second limbs is pre-corrected, so that respective postures of the second limbs after pre-correction and an interaction relationship between the second limbs after pre-correction can be pre-estimated. Single-limb constraint information between each first limb and the corresponding second limb is determined according to the limb posture information of each first limb and the predicted posture information of the corresponding second limb, and the generated single-limb constraint information enables the second limb to obtain the posture of the first limb. Limb interaction constraint information between the first object and the second object is determined according to the limb interaction information and predicted interaction information. The limb interaction constraint information enables multiple second limbs to obtain an interaction relationship between multiple first limbs. The initial trajectory information of each second limb is corrected according to the individual single-limb constraint information and the limb interaction constraint information, to obtain target trajectory information of each second limb, so that the second limbs of the second object can obtain postures consistent with those of the first limbs of the first object, and an interaction relationship between the second limbs keeps consistency with an interaction relationship between the first limbs, thereby enabling migration of trajectory information to be more accurate.

In one embodiment, the migration module 1202 is further configured to: determine a first limb length of each first limb, and determine a second limb length of each second limb; and adjust, for each first limb, the limb trajectory information of the first limb according to the first limb length of the first limb and the second limb length of the corresponding second limb, to obtain the initial trajectory information of each second limb.

In this embodiment, a first limb length of each first limb and a second limb length of each second limb are determined, and for each first limb, limb trajectory information of the first limb is adjusted according to the first limb length of the first limb and the second limb length of the corresponding second limb, to migrate the limb trajectory information of the first limb to the corresponding second limb. In addition, migration is performed with reference to limb length information, so that the migrated trajectory information conforms to limbs of a second object in terms of proportions, thereby roughly generating initial trajectory information of each second limb.

In one embodiment, the prediction module 1204 is further configured to: obtain candidate offset information of each iteration; and pre-correct, for each iteration, the initial trajectory information of each second limb based on the candidate offset information of the iteration, to obtain the predicted posture information of each second limb and the predicted interaction information between the at least two second limbs.

The correction module 1210 is further configured to correct, based on single-limb constraint information and limb interaction constraint information of each iteration, the initial trajectory information of each second limb, to obtain the target trajectory information of each second limb.

In this embodiment, candidate offset information of each iteration is obtained. For each iteration, initial trajectory information of each second limb is pre-corrected based on the candidate offset information of the iteration, to obtain predicted posture information of each second limb and predicted interaction information between at least two second limbs. The initial trajectory information can be pre-corrected by using the candidate offset information, to predict a posture of each second limb in a second object after correction, and to predict an interaction between the second limbs after correction. In addition, pre-correction is performed in each iteration, and the posture of a single second limb of the second object and the interaction between multiple second limbs may be predicted repeatedly through multiple iterations. In each iteration, single-limb constraint information between a first limb and the second limb is determined according to limb posture information before migration and the predicted posture information after pre-correction, so that the generated single-limb constraint information enables a single second limb to maintain a posture consistent with that of a single first limb in consideration of a posture characteristic of a single limb when limb information is migrated. Limb interaction constraint information between a first object and the second object in each iteration is generated according to limb interaction information and the predicted interaction information of each iteration. The limb interaction constraint information enables multiple second limbs to obtain an interaction relationship between multiple first limbs, so that migration of trajectory information is more accurate.

In one embodiment, the prediction module 1204 is further configured to: pre-correct, for each iteration, the initial trajectory information of each second limb based on the candidate offset information of the iteration, to obtain predicted trajectory information of each second limb; determine, based on the predicted trajectory information of each second limb, the predicted posture information of each second limb; and determine, based on the predicted trajectory information of each second limb, the predicted interaction information between the at least two second limbs.

In this embodiment, for each iteration, an initial start position and an initial end position of each second limb are corrected based on candidate offset information of the iteration, to obtain a predicted start position and a predicted end position corresponding to each second limb in the iteration, so that corresponding position information can be obtained based on correction under particular candidate offset information. According to the predicted start position and the predicted end position corresponding to each second limb in the iteration, respective posture information of the second limbs in the iteration can be accurately predicted, and interaction information between multiple second limbs can be accurately predicted.

In one embodiment, the initial trajectory information includes an initial start position and an initial end position of the second limb. The prediction module 1204 is further configured to: determine the second limb length of each second limb; determine, for each second limb, the predicted posture information of the second limb based on the predicted start position, the predicted end position, and the second limb length of the second limb; and determine, according to the predicted start position and the predicted end position of each second limb, the predicted interaction information between the at least two second limbs.

In this embodiment, for each iteration, an initial start position and an initial end position of each second limb are corrected based on candidate offset information of the iteration, to obtain a predicted start position and a predicted end position corresponding to each second limb in the iteration, so that corresponding position information can be obtained based on correction under particular candidate offset information. According to the predicted start position and the predicted end position corresponding to each second limb in the iteration, respective posture information of the second limbs in the iteration can be accurately predicted, and interaction information between multiple second limbs can be accurately predicted.

In one embodiment, the correction module 1210 is further configured to: screen out, for each second limb, the target offset information of the second limb from the candidate offset information of each iteration based on the single-limb constraint information and the limb interaction constraint information of each iteration; and correct, according to the target offset information of the second limb, the initial trajectory information of the second limb, to obtain the target trajectory information of the second limb.

In this embodiment, target offset information is screened by using single-limb constraint information and limb interaction constraint information in multiple iterations, so that the screened target offset information can satisfy constraints such as a single-limb constraint and a limb interaction constraint, and the determined target offset information can be more accurate. Initial trajectory information of a second limb is corrected according to the target offset information of the second limb, to obtain target trajectory information of the second limb, so that the corrected target trajectory information better conforms to characteristics of the second target limb, thereby improving trajectory migration accuracy.

In one embodiment, the correction module 1210 is further configured to: determine, according to the limb trajectory information of each first limb, limb speed information of each first limb; determine, in each iteration, predicted speed information of each second limb based on the predicted trajectory information of each second limb; determine, for each iteration, timing constraint information between each first limb and the corresponding second limb in the iteration based on the limb speed information of each first limb and the predicted speed information of the corresponding second limb in the iteration; and screen out, based on the single-limb constraint information, the limb interaction constraint information, and the timing constraint information of each iteration, the target offset information from the candidate offset information of each iteration.

In this embodiment, limb speed information of each first limb is determined according to limb trajectory information of each first limb. For each iteration, predicted speed information of each second limb in the iteration is determined based on initial trajectory information of each second limb and candidate offset information of the iteration, and timing constraint information between a first object and a second object in the iteration is generated based on the limb speed information of the multiple first limbs and the predicted speed information in the iteration, to constrain migration of limb trajectories in different moments by using the timing constraint information. For each second limb, target offset information is screened out from the candidate offset information of each iteration according to constraints such as single-limb constraint information, limb interaction constraint information, and timing constraint information of the second limb in each iteration, so that the determined target offset information better conforms to characteristics of the second limb, thereby improving trajectory migration accuracy.

In one embodiment, the limb trajectory information includes limb end positions of the first limb in at least two moments.

The correction module 1210 is further configured to: determine, for each first limb, a first time relationship of the first limb in the at least two moments; and determine, according to the limb end positions of the first limb in the at least two moments and the first time relationship, the limb speed information of the first limb.

In this embodiment, for each first limb, a first time relationship of the first limb in at least two moments is determined, and a time relationship of the same first limb in different moments can be determined. According to limb end positions of the first limb in at least two moments and the first time relationship, limb speed information of the first limb can be accurately determined.

In one embodiment, the initial trajectory information further includes initial end positions of the second limb in at least two moments, and the predicted trajectory information includes predicted end positions of the second limb in at least two moments.

The correction module 1210 is further configured to: determine, for each second limb in each iteration, a second time relationship of the second limb in the at least two moments; and determine, according to the predicted end positions of the second limb in the at least two moments and the second time relationship, the predicted speed information of the second limb.

In this embodiment, for each second limb in each iteration, a second time relationship of the second limb in at least two moments is determined, and a time relationship of the same second limb in different moments can be determined. Predicted speed information of the second limb is accurately determined according to the predicted end positions of the second limb in the at least two moments and the second time relationship.

In one embodiment, the first limb is connected to a first foot of the first object, and the second limb is connected to a second foot of the second object. The correction module 1210 is further configured to: determine a first foot length of each first foot, and determine a second foot length of each second foot; and determine, for each iteration, the timing constraint information between each first limb and the corresponding second limb in the iteration based on the limb speed information, the first foot length, the second foot length, and the predicted speed information in the iteration.

In this embodiment, a first foot length of each first foot and a second foot length of each second foot are determined, to generate timing constraint information between each first limb and a corresponding second limb in an iteration based on limb speed information, each first foot length, each second foot length, and predicted speed information in the iteration, so that migration of limb trajectories in different moments can be constrained by using the timing constraint information, and postures and interaction relationships of the first limb in different moments can be accurately migrated to the second limb in corresponding moments, thereby avoiding problems such as slipping of the migrated second limb caused by a timing disorder and further improving migration accuracy.

In one embodiment, the correction module 1210 is further configured to: screen out, for each second limb, target timing constraint information satisfying a timing condition from the timing constraint information of the second limb in each iteration; determine a target iteration to which the individual target timing constraint information belongs; and select, from the candidate offset information of the target iterations, candidate offset information obtained when the single-limb constraint information and the limb interaction constraint information in the corresponding target iteration satisfy a correction condition, as the target offset information of the second limb.

In one embodiment, the correction module 1210 is further configured to: determine a weight parameter of the single-limb constraint information and a weight parameter of the limb interaction constraint information; determine, according to the limb interaction constraint information, the single-limb constraint information, and the respective weight parameters, target constraint information corresponding to each second limb; and correct, based on the target constraint information corresponding to each second limb, the initial trajectory information of each second limb, to obtain the target trajectory information of each second limb.

In this embodiment, a weight parameter of single-limb constraint information and a weight parameter of limb interaction constraint information are determined, to determine proportions of the single-limb constraint information and the multi-joint chain constraint information in a trajectory migration process. In multiple iterations, target constraint information corresponding to each second limb in an iteration is accurately determined according to the limb interaction constraint information in the iteration, the single-limb constraint information corresponding to each second limb, and the weight parameters, so that offset information is finally selected in combination with the single-limb constraint information and the multi-joint chain constraint information, to accurately determine target trajectory information of each second limb.

In one embodiment, the limb trajectory information includes a limb start position and a limb end position of the first limb. The correction module 1210 is further configured to: determine, according to the limb start position and the limb end position of each first limb, the weight parameter of the single-limb constraint information; and determine, according to the weight parameter corresponding to the single-limb constraint information, the weight parameter corresponding to the limb interaction constraint information.

In this embodiment, a weight parameter of single-limb constraint information is determined according to a limb start position and a limb end position of each first limb, so that a proportion of the single-limb constraint information in a trajectory migration process can be determined based on the limb start positions and the limb end positions of the first limbs. A weight parameter corresponding to limb interaction constraint information is determined according to the weight parameter corresponding to the single-limb constraint information, to determine a proportion of the limb interaction constraint information in the trajectory migration process, so that target trajectory information of a second limb can be more accurately calculated according to the single-limb constraint information and the limb interaction constraint information.

In one embodiment, the limb trajectory information includes a limb start position and a limb end position of the first limb.

The prediction module 1204 is further configured to: determine the first limb length of each first limb; determine, for each first limb, the limb posture information of the first limb according to the limb start position, the limb end position, and the first limb length of the first limb; and determine, according to the limb start position and the limb end position of each first limb, the limb interaction information between the at least two first limbs.

In this embodiment, a first limb length of each first limb is determined, and for each first limb, limb posture information of the first limb can be accurately determined according to a limb start position, a limb end position, and the first limb length of the first limb. An interaction relationship between the first limbs can be accurately determined according to the limb start position and the limb end position of each first limb.

In one embodiment, the first limb includes a first joint chain, where the first joint chain is formed by connecting multiple joints of the first object and parts between the multiple joints. The second limb includes a second joint chain, where the second joint chain is formed by connecting multiple joints of the second object and parts between the multiple joints. The single-limb constraint information is constraint information between the first joint chain and the second joint chain. The limb interaction constraint information is constraint information between a first interaction relationship and a second interaction relationship, where the first interaction relationship is an interaction relationship between at least two first joint chains, and the second interaction relationship is an interaction relationship between at least two second joint chains.

In this embodiment, the single-limb constraint information is single-joint chain constraint information, and the single-joint chain constraint information is constraint information about a posture of a single joint chain. When limb trajectory information is migrated, the posture of the first joint chain is migrated to the second joint chain, so that the second joint chain has the posture of the first joint chain. The migrated posture is constrained by using the single-joint chain constraint information, so that the posture migrated to the second joint chain can conform to the second joint chain. The limb interaction constraint information is multi-joint chain interaction constraint information. The multi-joint chain interaction constraint information is constraint information about an interaction relationship of joint chains. When the limb trajectory information is migrated, a first interaction relationship between two first joint chains is migrated to two second joint chains, to obtain a second interaction relationship between the two second joint chains. During the migration, in consideration of cooperation between the two joint chains, migration of limb trajectories is more accurate.

The modules in the foregoing trajectory information processing apparatus may be implemented in whole or in part by software, hardware, and a combination thereof. The foregoing modules may be built in or independent of a processor of a computer device in a form of hardware, or may be stored in a memory of the computer device in a form of software, for the processor to invoke to execute operations corresponding to the foregoing modules.

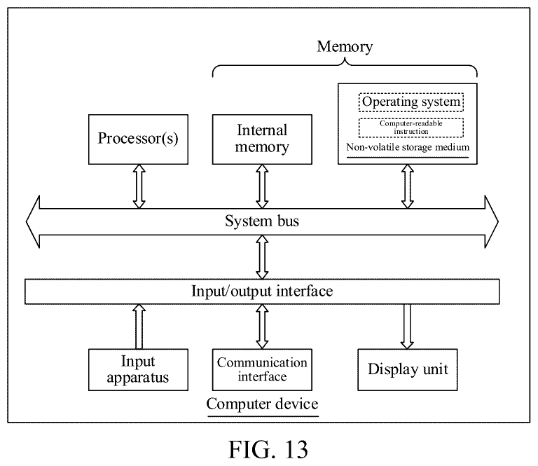

In one embodiment, a computer device is provided. The computer device may be a terminal or a server. The computer device is, for example, a terminal. A diagram of an internal structure of the terminal may be shown in FIG. 13. The computer device includes a processor, a memory, an input/output interface, a communication interface, a display unit, and an input apparatus. The processor, the memory, and the input/output interface are connected via a system bus. The communication interface, the display unit, and the input apparatus are connected to the system bus via the input/output interface. The processor of the computer device is configured to provide computing and control capabilities. The memory of the computer device includes a non-volatile storage medium and an internal memory. The non-volatile storage medium has an operating system and computer-readable instructions stored therein. The internal memory provides an operating environment for the operating system and the computer-readable instructions in the non-volatile storage medium. The input/output interface of the computer device is configured to exchange information between the processor and an external device. The communication interface of the computer device is configured to communicate with an external terminal in a wired or wireless mode. The wireless mode may be implemented through WIFI, a mobile cellular network, near field communication (NFC), or another technology. The computer-readable instructions, when executed by the processor, implement a trajectory information processing method. The display unit of the computer device is configured to form a visible picture, and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, mouse, or the like.

It will be appreciated by a person skilled in the art that the structure shown in FIG. 13 is merely a block diagram of a partial structure related to a solution in the present disclosure, and does not constitute a limitation to the computer device to which the solution in the present disclosure is applied. Specifically, the computer device may include more or fewer components than those shown in the figure, or some components may be combined, or a different component layout may be used.

In one embodiment, a computer device is further provided. The computer device includes a memory and a processor. The memory has computer-readable instructions stored therein. The processor, when executing the computer-readable instructions, implements the operations in the foregoing method embodiments.

In one embodiment, a computer-readable storage medium is provided. The computer-readable storage medium has computer-readable instructions stored therein. The computer-readable instructions, when executed by a processor, implement the operations in the foregoing method embodiments.

In one embodiment, a computer program product is provided, including computer-readable instructions. The computer-readable instructions, when executed by a processor, implement the operations in the foregoing method embodiments.

User information (including, but not limited to, user equipment information, user personal information, and the like) and data (including, but not limited to, data for analysis, stored data, displayed data, and the like) involved in the present disclosure are all information and data authorized by users or fully authorized by all parties, and collection, use, and processing of relevant data need to comply with relevant laws, regulations, and standards of relevant countries and regions.

It will be appreciated by a person of ordinary skill in the art that all or some of the procedures of the methods of the foregoing embodiments may be implemented by computer-readable instructions instructing relevant hardware. The computer-readable instructions may be stored in a non-volatile computer-readable storage medium. When the computer-readable instructions are executed, the procedures of the embodiments of the foregoing methods may be included. Any reference to a memory, a database, or another medium used in the embodiments provided in the present disclosure may include at least one of a non-volatile memory or a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may include a random access memory (RAM) or an external cache. As an illustration rather than a limitation, the RAM is available in various forms, such as a static random access memory (SRAM) or a dynamic random access memory (DRAM). The database involved in the embodiments provided in the present disclosure may include at least one of a relational database and a non-relational database. The non-relational database may include a blockchain-based distributed database, or the like, but is not limited thereto. The processor involved in the embodiments provided in the present disclosure may be a general-purpose processor, a central processing unit, a graphics processing unit, a digital signal processor, a programmable logic device, a quantum computing-based data processing logic device, or the like, but is not limited thereto.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of the present disclosure specifically and in detail, but cannot be construed as a limitation to the patent scope of the present disclosure. A person of ordinary skill in the art may make several transformations and improvements without departing from the idea of the present disclosure. These transformations and improvements fall within the protection scope of the present disclosure. Therefore, the protection scope of the patent of the present disclosure shall be subject to the appended claims.

What is claimed is:

1. A trajectory information processing method, performed by a computer device, the method comprising:
obtaining respective limb trajectory information of at least two first limbs of a first object, the at least two first limbs of the first object being in a one-to-one correspondence with at least two second limbs of a second object;
migrating the limb trajectory information from a first limb of the at least two first limbs of the first object to a corresponding second limb of the at least two second limbs of the second object, to obtain initial trajectory information of the second limb;
determining, based on the limb trajectory information of the first limb, limb posture information of the first limb and limb interaction information between the at least two first limbs;
pre-correcting the initial trajectory information of the second limb, to obtain predicted posture information of the second limb and predicted interaction information between the at least two second limbs;
determining, according to the limb posture information and the predicted posture information, single-limb constraint information between the first limb and the corresponding second limb;
determining, according to the limb interaction information and the predicted interaction information, limb interaction constraint information between the first object and the second object; and
correcting, based on the single-limb constraint information and the limb interaction constraint information, the initial trajectory information of the second limb, to obtain target trajectory information of the second limb.

2. The method according to claim 1, wherein migrating the limb trajectory information from the first limb of the first object to the corresponding second limb of the second object, to obtain the initial trajectory information of the second limb comprises:
determining a first limb length of the first limb, and determining a second limb length of the second limb; and
adjusting, for each first limb, the limb trajectory information of the first limb according to the first limb length of the first limb and the second limb length of the corresponding second limb, to obtain the initial trajectory information of the second limb.

3. The method according to claim 1, wherein pre-correcting the initial trajectory information of the second limb comprises:
obtaining candidate offset information of each iteration; and
pre-correcting, for each iteration, the initial trajectory information of the second limb based on the candidate offset information of the iteration, to obtain the predicted posture information of the second limb and the predicted interaction information between the at least two second limbs; and
correcting, based on the individual single-limb constraint information and the limb interaction constraint information, the initial trajectory information of the second limb, to obtain the target trajectory information of the second limb comprises:
correcting, based on single-limb constraint information and limb interaction constraint information of each iteration, the initial trajectory information of the second limb, to obtain the target trajectory information of the second limb.

4. The method according to claim 3, wherein pre-correcting, for each iteration, the initial trajectory information of the second limb based on the candidate offset information of the iteration, to obtain the predicted posture information of the second limb and the predicted interaction information between the at least two second limbs comprises:
pre-correcting, for each iteration, the initial trajectory information of the second limb based on the candidate offset information of the iteration, to obtain predicted trajectory information of the second limb;
determining, based on the predicted trajectory information of the second limb, the predicted posture information of the second limb; and
determining, based on the predicted trajectory information of the second limb, the predicted interaction information between the at least two second limbs.

5. The method according to claim 4, wherein the initial trajectory information comprises an initial start position and an initial end position of the second limb, and the predicted trajectory information comprises a predicted start position and a predicted end position of the second limb;
determining, based on the predicted trajectory information of the second limb, the predicted posture information of the second limb comprises:
determining the second limb length of the second limb; and
determining, for each second limb, the predicted posture information of the second limb based on the predicted start position, the predicted end position, and the second limb length of the second limb; and
determining, based on the predicted trajectory information of the second limb, the predicted interaction information between the at least two second limbs comprises:
determining, according to the predicted start position and the predicted end position of the second limb, the predicted interaction information between the at least two second limbs.

6. The method according to claim 5, wherein correcting, based on the single-limb constraint information and the limb interaction constraint information of each iteration, the initial trajectory information of the second limb, to obtain the target trajectory information of the second limb comprises:
screening out, for each second limb, the target offset information of the second limb from the candidate offset information of each iteration based on the single-limb constraint information and the limb interaction constraint information of each iteration; and
correcting, according to the target offset information of the second limb, the initial trajectory information of the second limb, to obtain the target trajectory information of the second limb.

7. The method according to claim 6, further comprising:
determining, according to the limb trajectory information of the first limb, limb speed information of the first limb;
determining, in each iteration, predicted speed information of the second limb based on the predicted trajectory information of the second limb; and
determining, for each iteration, timing constraint information between the first limb and the corresponding second limb in the iteration based on the limb speed information of the first limb and the predicted speed information of the corresponding second limb in the iteration, wherein
screening out the target offset information from the candidate offset information of the iteration based on the single-limb constraint information and the limb interaction constraint information of each iteration comprises:
screening out, based on the single-limb constraint information, the limb interaction constraint information, and the timing constraint information of each iteration, the target offset information from the candidate offset information of each iteration.

8. The method according to claim 7, wherein the limb trajectory information comprises limb end positions of the first limb in at least two moments; and determining, according to the limb trajectory information of the first limb, the limb speed information of the first limb comprises:
determining, for each first limb, a first time relationship of the first limb in the at least two moments; and
determining, according to the limb end positions of the first limb in the at least two moments and the first time relationship, the limb speed information of the first limb.

9. The method according to claim 7, wherein the initial trajectory information further comprises initial end positions of the second limb in at least two moments, and the predicted trajectory information comprises predicted end positions of the second limb in at least two moments; and
determining, in each iteration, the predicted speed information of the second limb based on the predicted trajectory information of the second limb comprises:
determining, for each second limb in each iteration, a second time relationship of the second limb in the at least two moments; and
determining, according to the predicted end positions of the second limb in the at least two moments and the second time relationship, the predicted speed information of the second limb.

10. The method according to claim 7, wherein the first limb is connected to a first foot of the first object, and the second limb is connected to a second foot of the second object; and
determining, for each iteration, the timing constraint information between the first limb and the corresponding second limb in the iteration based on the limb speed information of the first limb and the predicted speed information of the corresponding second limb in the iteration comprises:
determining a first foot length of the first foot, and determining a second foot length of the second foot; and
determining, for each iteration, the timing constraint information between the first limb and the corresponding second limb in the iteration based on the limb speed information, the first foot length, the second foot length, and the predicted speed information in the iteration.

11. The method according to claim 7, wherein screening out, based on the single-limb constraint information, the limb interaction constraint information, and the timing constraint information of each iteration, the target offset information from the candidate offset information of each iteration comprises:
screening out, for each second limb, target timing constraint information satisfying a timing condition from the timing constraint information of the second limb in each iteration;
determining a target iteration to which the individual target timing constraint information belongs; and
selecting, from the candidate offset information of the target iterations, candidate offset information obtained when the single-limb constraint information and the limb interaction constraint information in the corresponding target iteration satisfy a correction condition, as the target offset information of the second limb.

12. The method according to claim 1, wherein correcting, based on the single-limb constraint information and the limb interaction constraint information, the initial trajectory information of the second limb, to obtain the target trajectory information of the second limb comprises:
determining a weight parameter of the single-limb constraint information and a weight parameter of the limb interaction constraint information;
determining, according to the limb interaction constraint information, the single-limb constraint information, and the respective weight parameters, target constraint information corresponding to the second limb; and
correcting, based on the target constraint information corresponding to the second limb, the initial trajectory information of the second limb, to obtain the target trajectory information of the second limb.

13. The method according to claim 12, wherein the limb trajectory information comprises a limb start position and a limb end position of the first limb; and determining the weight parameter of the single-limb constraint information and the weight parameter of the limb interaction constraint information comprises:
determining, according to the limb start position and the limb end position of the first limb, the weight parameter of the single-limb constraint information; and
determining, according to the weight parameter of the single-limb constraint information, the weight parameter of the limb interaction constraint information.

14. The method according to claim 1, wherein the limb trajectory information comprises a limb start position and a limb end position of the first limb; and
determining, based on the limb trajectory information of the first limb, the limb posture information of the first limb and the limb interaction information between the at least two first limbs comprises:
determining the first limb length of the first limb;
determining, for each first limb, the limb posture information of the first limb according to the limb start position, the limb end position, and the first limb length of the first limb; and
determining, according to the limb start position and the limb end position of the first limb, the limb interaction information between the at least two first limbs.

15. The method according to claim 1, wherein the first limb comprises a first joint chain, the first joint chain being formed by connecting multiple joints of the first object and parts between the multiple joints; the second limb comprises a second joint chain, the second joint chain being formed by connecting multiple joints of the second object and parts between the multiple joints; the single-limb constraint information is constraint information between the first joint chain and the second joint chain; and the limb interaction constraint information is constraint information between a first interaction relationship and a second interaction relationship, the first interaction relationship being an interaction relationship between at least two first joint chains, and the second interaction relationship being an interaction relationship between at least two second joint chains.

16. A computer device, comprising one or more processors and a memory containing computer-readable instructions that, when being executed, cause the one or more processors to perform:
obtaining respective limb trajectory information of at least two first limbs of a first object, the at least two first limbs of the first object being in a one-to-one correspondence with at least two second limbs of a second object;
migrating the limb trajectory information from a first limb of the at least two first limbs of the first object to a corresponding second limb of the at least two second limbs of the second object, to obtain initial trajectory information of the second limb;
determining, based on the limb trajectory information of the first limb, limb posture information of the first limb and limb interaction information between the at least two first limbs;
pre-correcting the initial trajectory information of the second limb, to obtain predicted posture information of each second limb and predicted interaction information between the at least two second limbs;
determining, according to the limb posture information and the predicted posture information, single-limb constraint information between the first limb and the corresponding second limb;
determining, according to the limb interaction information and the predicted interaction information, limb interaction constraint information between the first object and the second object; and
correcting, based on the single-limb constraint information and the limb interaction constraint information, the initial trajectory information of the second limb, to obtain target trajectory information of the second limb.

17. The device according to claim 16, wherein the one or more processors are further configured to perform:
determining a first limb length of the first limb, and determining a second limb length of the second limb; and
adjusting, for each first limb, the limb trajectory information of the first limb according to the first limb length of the first limb and the second limb length of the corresponding second limb, to obtain the initial trajectory information of the second limb.

18. The device according to claim 16, wherein the one or more processors are further configured to perform:
obtaining candidate offset information of each iteration; and
pre-correcting, for each iteration, the initial trajectory information of the second limb based on the candidate offset information of the iteration, to obtain the predicted posture information of the second limb and the predicted interaction information between the at least two second limbs; and
correcting, based on the individual single-limb constraint information and the limb interaction constraint information, the initial trajectory information of the second limb, to obtain the target trajectory information of the second limb comprises:
correcting, based on single-limb constraint information and limb interaction constraint information of each iteration, the initial trajectory information of the second limb, to obtain the target trajectory information of the second limb.

19. The device according to claim 18, wherein the one or more processors are further configured to perform:
pre-correcting, for each iteration, the initial trajectory information of the second limb based on the candidate offset information of the iteration, to obtain predicted trajectory information of the second limb;
determining, based on the predicted trajectory information of the second limb, the predicted posture information of the second limb; and
determining, based on the predicted trajectory information of the second limb, the predicted interaction information between the at least two second limbs.

20. A non-transitory computer-readable storage medium containing computer-readable instructions that, when being executed, cause at least one processor to perform:
obtaining respective limb trajectory information of at least two first limbs of a first object, the at least two first limbs of the first object being in a one-to-one correspondence with at least two second limbs of a second object;
migrating the limb trajectory information from a first limb of the at least two first limbs of the first object to a corresponding second limb of the at least two second limbs of the second object, to obtain initial trajectory information of the second limb;
determining, based on the limb trajectory information of the first limb, limb posture information of the first limb and limb interaction information between the at least two first limbs;
pre-correcting the initial trajectory information of the second limb, to obtain predicted posture information of each second limb and predicted interaction information between the at least two second limbs;
determining, according to the limb posture information and the predicted posture information, single-limb constraint information between the first limb and the corresponding second limb;
determining, according to the limb interaction information and the predicted interaction information, limb interaction constraint information between the first object and the second object; and
correcting, based on the single-limb constraint information and the limb interaction constraint information, the initial trajectory information of the second limb, to obtain target trajectory information of the second limb.
